(19) United States
(12) Patent Application Publication
(10) Pub. No.: US 2023/0378452 A1
(43) Pub. Date: Nov. 23, 2023

(54) TERNARY OXIDE MATERIALS FOR NI-RICH CATHODE MATERIALS FOR RECHARGEABLE BATTERIES

(71) Applicant: Rivian IP Holdings, LLC, Irvine, CA (US)

(72) Inventors: Soo Kim, Fremont, CA (US); Ki Tae Park, Santa Clara, CA (US); Johnson Mark, San Jose, CA (US); Victor Prajapati, San Francisco, CA (US)

(21) Appl. No.: 17/751,092

(22) Filed: May 23, 2022

(51) Int. Cl. H01M 4/525; H01M 10/0525; H01M 4/505

(52) U.S. Cl. CPC H01M 4/525; H01M 10/0525; H01M 4/505; H01M 2004/027

(57) ABSTRACT

A cathode active material includes a bulk nickel-rich cathode active material having a lithium metal oxide coating on a surface of the bulk nickel-rich cathode active material, wherein the lithium metal oxide coating exhibits one or more of the following: a greater PF₅⁻ score when normalized to that of LiAlO₂ at 100%; a greater HF score when normalized to that of LiAlO₂ at 100%; or in absolute terms, an enthalpy of reaction value that is less than 0.351.

### INTRODUCTION

The present technology is generally related to lithium rechargeable batteries. More particularly the technology relates to coating materials for secondary rechargeable batteries.

### SUMMARY

Described herein are ternary lithium metal oxide (Li-M-O) materials that may be used as coating materials on the surface of either high-nickel content cathode active materials or on the cathode current collectors in lithium ion batteries (LIBs). The coatings are ionically conductive while being electronically insulating, and they protecting the underlying cathode active material from reaction with more conventional coating materials or electrolyte degradation products. Accordingly, herein we provide for coatings based upon such ternary lithium metal oxides, methods for the preparation, and methods for their incorporation into LIBs.

In one aspect, a cathode active material includes a particulate bulk nickel-rich cathode active material having a ternary lithium metal oxide coating on a surface of the particulate bulk cathode active material, where the ternary lithium metal oxide is other than LiAlO₂.

In one aspect, a cathode active material includes a particulate bulk cathode active material having a lithium metal oxide coating on a surface of the particulate bulk cathode active material, wherein the lithium metal oxide coating exhibits one or more of the following: a greater PF₅⁻ score when normalized to that of LiAlO₂ at 100%; a greater HF score when normalized to that of LiAlO₂ at 100%; or in absolute terms, an enthalpy of reaction value that is less than −0.351 eV/atom. In some embodiments, the lithium metal oxide entirely covers, continuously, the cathode active material. In some embodiments, the lithium metal oxide may be Li₅AlO₄, Li₄TiO₄, Li₅FeO₄, LiNiO₂, Li₃CuO₃, Li₆Zr₂O₇, Li₈Nb₂O₉, Li₃NbO₄, Li₄MoO₅, Li₂MoO₄, Li₂SnO₃, Li₈SnO₆, Li₂FeO₃, LiYO₂, Li₅SbO₅, LiScO₂, Li₂TiO₃, Li₂MnO₃, LiFeO₂, Li₂CoO₃, LiNi₂O₄, Li₂NiO₃, Li₂ZrO₃, or a mixture of any two or more thereof. In any of the above embodiments, the bulk cathode active material may be a nickel-rich cathode active material.

In another aspect, a current collector includes a metal coated with a lithium metal oxide, wherein the lithium metal oxide coating exhibits one or more of the following: a greater PF₅⁻ score when normalized to that of LiAlO₂ at 100%; a greater HF score when normalized to that of LiAlO₂ at 100%; or in absolute terms, an enthalpy of reaction value that is less than −0.351 eV/atom. In some embodiments, the lithium metal oxide may be Li₅AlO₄, Li₄TiO₄, Li₅FeO₄, LiNiO₂, Li₃CuO₃, Li₆Zr₂O₇, Li₈Nb₂O₉, Li₃NbO₄, Li₄MoO₅, Li₂MoO₄, Li₂SnO₃, Li₈SnO₆, Li₂FeO₃, LiYO₂, Li₅SbO₅, LiScO₂, Li₂TiO₃, Li₂MnO₃, LiFeO₂, Li₂CoO₃, LiNi₂O₄, Li₂NiO₃, Li₂ZrO₃, or a mixture of any two or more thereof.

In another aspect, a battery cell includes a cathode comprising a bulk cathode active material and a current collector; an anode; a separator; an electrolyte; and a housing; wherein one or more of the cathode active material, the current collector, or an inner surface of the housing is at least partially coated with a lithium metal oxide, wherein the lithium metal oxide coating exhibits one or more of the following: a greater PF₅⁻ score when normalized to that of LiAlO₂ at 100%; a greater HF score when normalized to that of LiAlO₂ at 100%; or in absolute terms, an enthalpy of reaction value that is less than −0.351 eV/atom. In some embodiments, the lithium metal oxide entirely covers, continuously, the cathode active material, the current collector, or an inner surface of the housing. In some embodiments, the lithium metal oxide may be Li₅AlO₄, Li₄TiO₄, Li₅FeO₄, LiNiO₂, Li₃CuO₃, Li₆Zr₂O₇, Li₈Nb₂O₉, Li₃NbO₄, Li₄MoO₅, Li₂MoO₄, Li₂SnO₃, Li₈SnO₆, Li₂FeO₃, LiYO₂, Li₅SbO₅, LiScO₂, Li₂TiO₃, Li₂MnO₃, LiFeO₂, Li₂CoO₃, LiNi₂O₄, Li₂NiO₃, Li₂ZrO₃, or a mixture of any two or more thereof.

In another aspect, a cathode active material includes a particulate bulk nickel-rich cathode active material having a ternary lithium metal oxide coating on a surface of the particulate bulk cathode active material, wherein the ternary lithium metal oxide is other than LiAlO₂.

In another further aspect, a current collector includes a metal coated with a cathode active material comprising a particulate bulk nickel-rich cathode active material having a ternary lithium metal oxide coating on a surface of the particulate bulk cathode active material, wherein the ternary lithium metal oxide is other than LiAlO₂.

In a further aspect, a lithium ion battery includes a cathode comprising a bulk cathode active material and a current collector; an anode; a separator; an electrolyte; and a housing; wherein: the bulk cathode active material is a nickel-rich cathode active material having a ternary lithium metal oxide coating on a surface of the particulate bulk cathode active material, wherein the ternary lithium metal oxide is other than LiAlO₂.

In another aspect, a battery includes a plurality of battery cells, each cell as described herein. Such batteries may comprise a bank of battery cells, a power unit in a vehicle, or a battery or battery cell within an electric vehicle. In further aspect, an electric vehicle comprises any of the batteries or battery cells embodied herein.

### BRIEF DESCRIPTION OF THE DRAWINGS

FIG. 1 is calculated reaction energy profile for a chemical reaction between LiAlO₂ and NMC811, where the x-axis shows the molar fraction of NMC811 (x=0 is 100% LiAlO₂ and x=1 is 100% NMC811) and the y-axis describes the reaction enthalpy in eV/atom, as illustrated in the examples.

FIG. 2 is calculated reaction energy profile for a chemical reaction between Al₂O₃ and NMC811, where the x-axis shows the molar fraction of NMC811 (x=0 is 100% Al₂O₃ and x=1 is 100% NMC811) and the y-axis describes the reaction enthalpy in eV/atom, as illustrated in the examples.

FIG. 3 is a ternary lithium metal oxide screening workflow diagram.

FIG. 4 is an illustration of a cross-sectional view of an electric vehicle, according to various embodiments.

FIG. 5 is a depiction of an illustrative battery pack, according to various embodiments.

FIG. 6 is a depiction of an illustrative battery module, according to various embodiments.

FIGS. 7A, 7B, and 7C are cross sectional illustrations of various batteries, according to various embodiments.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

One of the most common methods to prevent degradation in lithium ion batteries (“LIBs”), is to utilize a protective coating on the electroactive species, particularly with regard to the cathode active materials used in the batteries. Typically, metal oxide-type coatings are used to withstand the harsh operating conditions within the LIBs. Cathode decomposition may occur during the structural phase transition (i.e. where lithium ions (de-)insert from the electrode material) and/or when in contact with other components of the LIBs, such as the electrolytes and current collectors. Illustrative commercially available cathode active materials include, but are not limited to, LiCoO₂, Li(NiₐMn_{b}Co_{c})O₂ (also referred to a NMC materials), Li(NiₐCo_{b}Al_{c})O₂ (also referred to a NCA materials), Li(Ni_{d}CoₑMn_{f}Al_{g})O₂ (also referred to a NCMA materials), and Li(Mn_{α}Ni_{β})₂O₄, where a+b+c=1, d+e+f+g=1 and α+β=1. Coatings on such cathode active material provide for: 1) formation of a modified solid electrolyte interface (SEI), which helps stabilize the interface between the electrode and electrolyte; 2) improvements in electrolyte wetting to ensure uniform Li⁺ ion insertion and de-insertion; and, 3) suppression of surface phase transitions of cathode material (i.e., surface decomposition) as a physical barrier.

Li(NiₐMn_{b}Co_{c})O₂ cathode materials (“LiNMC”) can operate at high voltage—e.g. above 4 V vs. Li/Li⁺. At such high voltages, especially during the first cycle charge cell formation step, electrolyte decomposition is prevalent, typically starting at about 4.2 V vs. Li/Li⁺. Al₂O₃ has been one of the more studied binary oxide coatings that have been utilized in LIBs. From a cell cycling perspective, it is beneficial to incorporate Al₂O₃ or other binary metal oxide materials as electrode coating materials. However, it has now been found that when applied to the NMC, the Al₂O₃ consumes Li ions and undergoes a phase transition. For example, when Ni-rich LiNi_{0.8}Mn_{0.1}Co_{0.1}O₂ (NMC811) cathode active material reacts with a Al₂O₃ coating, the following reaction takes place:

0.319LiNi_{0.8}Mn_{0.1}Co_{0.1}O₂+0.681Al₂O₃→0.082Ni₃O₄+0.006Li₄MnCo₅O₁₂+0.003LiO₈+0.273LiAl₅O₈+0.008Li₂Mn₃NiO₈

This reaction exhibits an enthalpy (Eᵣₓₙ) of −0.033 eV/atom. It is evident that Al₂O₃ is not consumed upon activation, but it causes the NMC811 cathode materials to decompose. However, it has now been found that if a ternary Li-M-O were to be used as the coating, it is stable when in contact with the NMC811. Accordingly, herein we provide for coatings based upon such ternary lithium metal oxides, methods for the preparation, and methods for their incorporation into LIBs.

In one aspect, a cathode active material is provided that includes a particulate bulk cathode active material having a lithium metal oxide coating on at least a portion of the surface of the particulate bulk cathode active material. The lithium metal oxide is other than LiAlO₂, and exhibits one or more of the following: a greater PF₅⁻ score when normalized to that of LiAlO₂ at 100%; a greater HF score when normalized to that of LiAlO₂ at 100%; or in absolute terms, an enthalpy of reaction value that is less than 0.351. By expressing the comparison to the LiAlO₂ direct comparisons to the baseline Li-M-O (i.e. LiAlO₂) may be readily determined. Thus, the coatings described herein provide superior protection to that of LiAlO₂.

As used herein, the HF and PF₅⁻ scores are determined based upon the model reaction that is to be run. The molar ratio of components (HF or PF₅⁻) to Li-M-O is first determined (ratio 1). The ratio is then normalized to the ratio for the baseline reaction of LiAlO₂ by dividing ratio 1 (for LiAlO₂) by ratio 1 (for the Li-M-O of interest) to arrive at value 2. The enthalpy of reaction (Eᵣₓₙ) in eV/atom is then determined from the calculation, however this is then normalized to the Eᵣₓₙ for LiAlO₂ dividing by Eᵣₓₙ (for LiAlO₂) by the Eᵣₓₙ (for the Li-M-O of interest) to arrive at value 2. Value 1 and 2 are then summed, however they are based upon molar ratios. To convert the values to weight-based values, the sum is then divided by the molecular weight of the Li-M-O multiplied by 1000. The PF₅⁻ or HF score is then determined by dividing the per weight value for the LiAlO₂ by the per weight value of the Li-M-O multiplied by 100. Expressed another way, the PF₅⁻ or HF score is a percentage improvement (or diminution) for that reaction compared to the baseline LiAlO₂ value. Illustrative calculations are shown in the examples.

As used herein, the phrase “in absolute terms, an enthalpy of reaction value” refers to the calculated Eᵣₓₙ value, typically a negative number, as the absolute value (i.e. the value without regard to positive or negative). For example, the Eᵣₓₙ value for LiAlO₂ is −0.351 eV/atom, however expressed as the absolute value (without regard to units) it is 0.351.

In some embodiments, the lithium metal oxide is Li₅AlO₄, Li₄TiO₄, Li₅FeO₄, LiNiO₂, Li₃CuO₃, Li₆Zr₂O₇, Li₈Nb₂O₉, Li₃NbO₄, Li₄MoO₅, Li₂MoO₄, Li₂SnO₃, Li₈SnO₆, Li₂FeO₃, LiYO₂, Li₅SbO₅, LiScO₂, Li₂TiO₃, Li₂MnO₃, LiFeO₂, Li₂CoO₃, LiNi₂O₄, Li₂NiO₃, Li₂ZrO₃, or a mixture of any two or more thereof. In other embodiments, the lithium metal oxide is Li₅AlO₄, Li₄TiO₄, Li₅FeO₄, LiNiO₂, Li₃CuO₃, Li₆Zr₂O₇, Li₈Nb₂O₉, Li₃NbO₄, Li₄MoO₅, Li₂MoO₄, Li₂SnO₃, Li₈SnO₆, Li₂FeO₃, LiYO₂, Li₅SbO₅, or a mixture of any two or more thereof. In further embodiments, the lithium metal oxide is Li₅AlO₄, Li₄TiO₄, Li₅FeO₄, LiNiO₂, Li₃CuO₃, Li₆Zr₂O₇, Li₈Nb₂O₉, Li₃NbO₄, Li₄MoO₅, Li₂MoO₄, Li₂SnO₃, Li₈SnO₆, or a mixture of any two or more thereof.

As noted above, the cathode active material includes a particulate bulk cathode active material. As used herein, the bulk cathode active material is the core of the particle that is coated with a thin layer of the lithium metal oxide coating on the surface. Generally, the bulk cathode active material may be a nickel-rich cathode active material. Illustrative nickel-rich cathode active materials include materials such as lithium nickel-manganese-cobalt oxide (“NMC”) cathode materials, lithium cobalt oxides, lithium nickel manganese oxides, NCA, NCMA and the like, and mixtures of any two or more thereof. In some embodiments, the bulk cathode active material may be Li(NiₐMn_{b}Co_{c})O₂, wherein 0≤a≤1, 0≤b≤1, 0≤c≤1, and a+b+c=1. In some embodiments, the bulk cathode active material may be Li(NiₐMn_{b}Co_{c})O₂, wherein 0<a<1, 0<b<1, 0<c<1, and a+b+c=1. In further embodiments, the bulk cathode active material may be LiCoO₂, Li(NiₐMn_{b}Co_{c})O₂, or Li(Mn_{α}Ni_{β})₂O₄, wherein a+b+c=1, and α+β=1. In yet other embodiments, the bulk cathode active material may be LiCoO₂, Li(NiₐMn_{b}Co_{c})O₂, or Li(Mn_{α}Ni_{β})₂O₄, wherein 0<a<1, 0≤b<1, 0≤c<1, a+b+c=1, 0≤α<1, 0<β<1, and α+β=1. In some embodiments, the cathode active material has a nickel content of 70 wt % or greater, 80 wt % or greater, or 85 wt % or greater.

Alternatively, or in addition, to a coating of lithium metal oxide on the cathode active material, the lithium metal oxide may be coated or deposited on other surfaces within a battery cell or within a battery pouch or within a battery housing. Accordingly, in another aspect, the lithium metal oxide may be used as a coating on a current collector, on the separator, inside a pouch, or inside a housing such that the lithium metal oxide can scavenge deleterious species in the electrolyte solution such as, but not limited to, HF, PF₅, LiOH, and the like.

In another aspect, a current collector includes a metal coated with a lithium metal oxide, wherein the lithium metal oxide coating exhibits one or more of the following: a greater PF₅⁻ score when normalized to that of LiAlO₂ at 100%; a greater HF score when normalized to that of LiAlO₂ at 100%; or in absolute terms, an enthalpy of reaction value that is less than 0.351.

In some embodiments, the lithium metal oxide is Li₅AlO₄, Li₄TiO₄, Li₅FeO₄, LiNiO₂, Li₃CuO₃, Li₆Zr₂O₇, Li₈Nb₂O₉, Li₃NbO₄, Li₄MoO₅, Li₂MoO₄, Li₂SnO₃, Li₈SnO₆, Li₂FeO₃, LiYO₂, Li₅SbO₅, LiScO₂, Li₂TiO₃, Li₂MnO₃, LiFeO₂, Li₂CoO₃, LiNi₂O₄, Li₂NiO₃, Li₂ZrO₃, or a mixture of any two or more thereof. In other embodiments, the lithium metal oxide is Li₅AlO₄, Li₄TiO₄, Li₅FeO₄, LiNiO₂, Li₃CuO₃, Li₆Zr₂O₇, Li₈Nb₂O₉, Li₃NbO₄, Li₄MoO₅, Li₂MoO₄, Li₂SnO₃, Li₈SnO₆, Li₂FeO₃, LiYO₂, Li₅SbO₅, or a mixture of any two or more thereof. In further embodiments, the lithium metal oxide is Li₅AlO₄, Li₄TiO₄, Li₅FeO₄, LiNiO₂, Li₃CuO₃, Li₆Zr₂O₇, Li₈Nb₂O₉, Li₃NbO₄, Li₄MoO₅, Li₂MoO₄, Li₂SnO₃, Li₈SnO₆, or a mixture of any two or more thereof.

The cathode current collector may include a metal that is aluminum, copper, nickel, titanium, stainless steel, or carbonaceous materials. In some embodiments, the metal of the current collector is in the form of a metal foil. In some specific embodiments, the current collector is an aluminum (Al) or copper (Cu) foil. In some embodiments, the current collector is a metal alloy, made of Al, Cu, Ni, Fe, Ti, or combination thereof. In another embodiment, the metal foils maybe coated with carbon: e.g., carbon-coated Al foil, and the like.

The materials described herein are all intended for use in electrochemical devices such as, but not limited to, lithium ion batteries. Accordingly, in another aspect, a lithium ion battery includes a cathode including a bulk cathode active material and a current collector; an anode; a separator; an electrolyte; and a housing. The housing may be a pouch in which a battery cell is contained, or it may be the housing the battery in which the pouches are contained. In the lithium ion battery, one or more of the cathode active material, the current collector, or an inner surface of the housing is at least partially coated with a lithium metal oxide, wherein the lithium metal oxide coating exhibits one or more of the following: a greater PF₅⁻ score when normalized to that of LiAlO₂ at 100%; a greater HF score when normalized to that of LiAlO₂ at 100%; or in absolute terms, an enthalpy of reaction value that is less than 0.351.

In other embodiments, a lithium ion battery includes a cathode including a bulk cathode active material and a current collector; an anode; a separator; an electrolyte; and a housing. The housing may be a pouch in which a battery cell is contained, or it may be the housing the battery in which the pouches are contained. In the lithium ion battery, one or more of the cathode active material, the current collector, or an inner surface of the housing is at least partially coated with a lithium metal oxide, wherein the lithium metal oxide is Li₅AlO₄, Li₄TiO₄, Li₅FeO₄, LiNiO₂, Li₃CuO₃, Li₆Zr₂O₇, Li₈Nb₂O₉, Li₃NbO₄, Li₄MoO₅, Li₂MoO₄, Li₂SnO₃, Li₈SnO₆, Li₂FeO₃, LiYO₂, Li₅SbO₅, LiScO₂, Li₂TiO₃, Li₂MnO₃, LiFeO₂, Li₂CoO₃, LiNi₂O₄, Li₂NiO₃, Li₂ZrO₃, or a mixture of any two or more thereof. In some embodiments, the bulk cathode active material is a nickel rich cathode active material. In other embodiments, the bulk cathode active material is a lithium nickel-manganese-cobalt oxide (“NMC”) cathode material.

In the lithium ion batteries, the anode may include lithium metal, graphite, Si, SiOₓ, Si nanowire, lithiated Si, or a mixture of any two or more thereof. The anodes may be a source of lithium or provide a lattice within which the lithium may be intercalated from the cathode. Additionally, the electrolyte of the lithium batteries may be either a solution phase electrolyte or a solid-state electrolyte. In some embodiments, the anode may comprise a current collector (e.g., Cu foil) and an in situ-formed anode (e.g., Li metal) on a surface of the current collector facing the separator or solid-state electrolyte such that in an uncharged state. In such embodiments, the assembled cell does not comprise an anode active material.

In another aspect, a process for manufacturing a cathode for a lithium ion battery is provided. The process includes mixing a lithium metal oxide coated cathode active material with conductive carbon and a binder in a solvent to form a slurry, coating the slurry onto a cathode current collector, and removing the solvent. The loading level of cathode materials on the cathode current collector (after solvent removal) may range from about 5 mg/cm2 to about 50 mg/cm2, and the packing density may vary from about 1.0 g/cc to about 5.0 g/cc.

Generally, the conductive carbon species may include graphite, carbon black, carbon nanotubes, and the like. Illustrative conductive carbon species include graphite, carbon black, Super P carbon black material, Ketjen Black, Acetylene Black, SWCNT, MWCNT, graphite, carbon nanofiber, and/or graphene, graphite.

Illustrative binders may include, but are not limited to, polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Other illustrative binder materials can include one or more of: agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrilic acid (PAA), poly(methyl acrylate) (PMA), poly(vinyl alcohol) (PVA), poly(vinyl acetate) (PVAc), polyacrylonitrile (PAN), polyisoprene (Plpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof.

The solvent used in the slurry formation may be a ketone, an ether, a heterocyclic ketone, and/or distilled water. One illustrative solvent is N-methylpyrrolidone (“NMP”). The solvent may be removed by allowing the solvent to evaporate at ambient or elevated temperature, or at ambient pressure or reduced pressure. Handling of the cathode and other lithium ion battery internal components may be conducted under an inert atmosphere (N₂, He, Ag, etc.), according to some embodiments.

In another aspect, the present disclosure provides a battery pack comprising the cathode active material, the electrochemical cell, or the lithium ion battery of any one of the above embodiments. The battery pack may find a wide variety of applications including but are not limited to general energy storage or in vehicles.

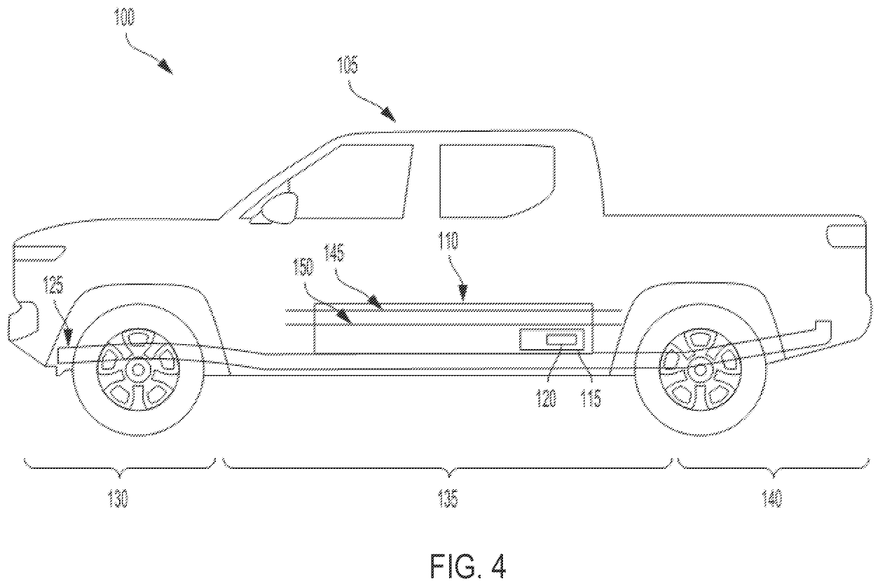

In another aspect, a plurality of battery cells as described above may be used to form a battery and/or a battery pack, that may find a wide variety of applications such as general storage, or in vehicles. By way of illustration of the use of such batteries or battery packs in an electric vehicle, FIG. 4 depicts is an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery modules 115 or the battery cells 120 with other electrical components of the electric vehicle 105 to provide electrical power to various systems or components of the electric vehicle 105.

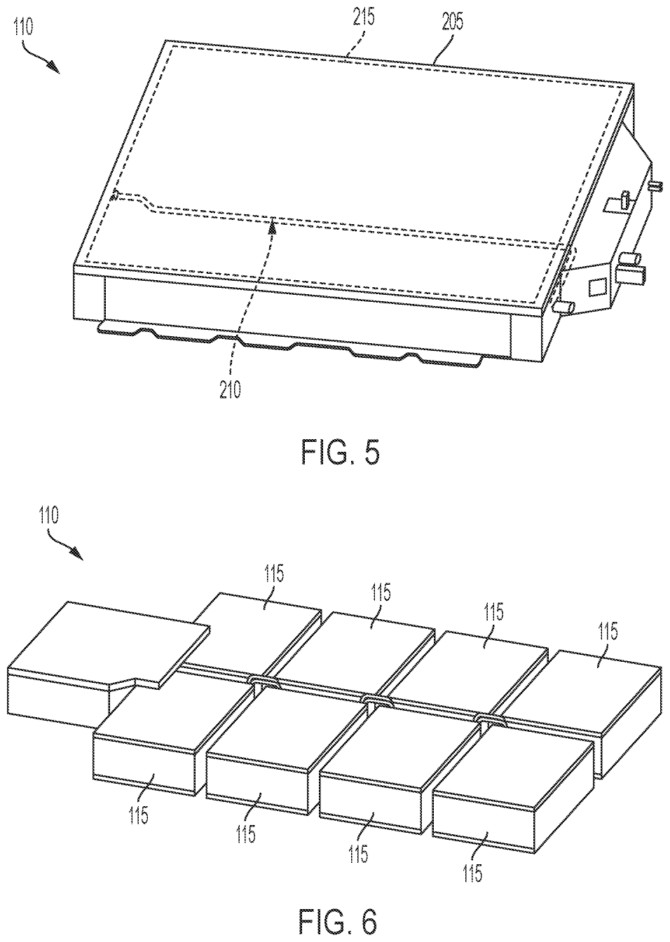

FIG. 5 depicts an example battery pack 110. Referring to FIG. 5, among others, the battery pack 110 can provide power to electric vehicle 105. Battery packs 110 can include any arrangement or network of electrical, electronic, mechanical or electromechanical devices to power a vehicle of any type, such as the electric vehicle 105. The battery pack 110 can include at least one housing 205. The housing 205 can include at least one battery module 115 or at least one battery cell 120, as well as other battery pack components. The housing 205 can include a shield on the bottom or underneath the battery module 115 to protect the battery module 115 from external conditions, for example if the electric vehicle 105 is driven over rough terrains (e.g., off-road, trenches, rocks, etc.) The battery pack 110 can include at least one cooling line 210 that can distribute fluid through the battery pack 110 as part of a thermal/temperature control or heat exchange system that can also include at least one thermal component (e.g., cold plate) 215. The thermal component 215 can be positioned in relation to a top submodule and a bottom submodule, such as in between the top and bottom submodules, among other possibilities. The battery pack 110 can include any number of thermal components 215. For example, there can be one or more thermal components 215 per battery pack 110, or per battery module 115. At least one cooling line 210 can be coupled with, part of, or independent from the thermal component 215.

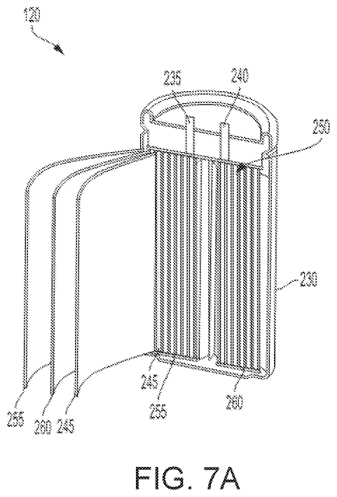

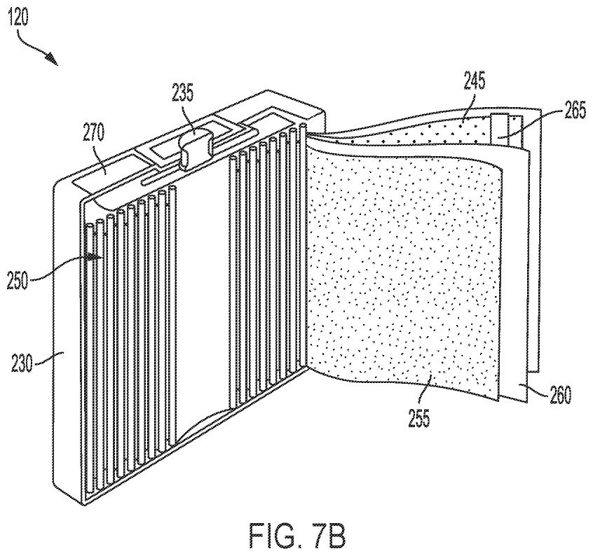

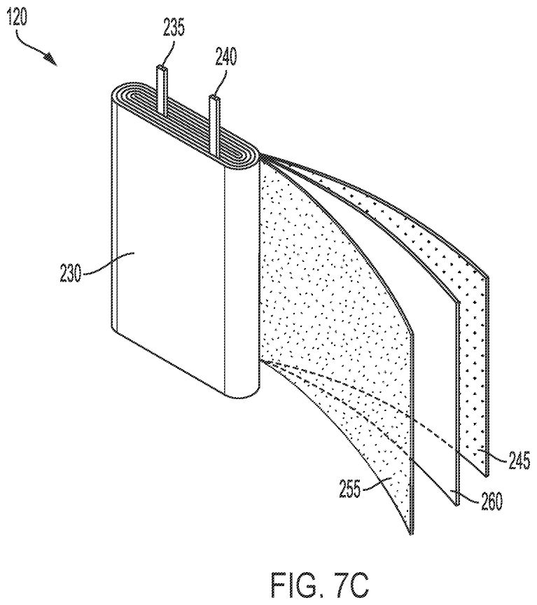

FIG. 6 depicts example battery modules 115, and FIGS. 7A, 7B, and 7C depict illustrative cross sectional views of battery cells 120 in various forms. For example FIG. 7A is a cylindrical cell, 7B is a prismatic cell, and 7C is the cell for use in a pouch. The battery modules 115 can include at least one submodule. For example, the battery modules 115 can include at least one first (e.g., top) submodule 220 or at least one second (e.g., bottom) submodule 225. At least one thermal component 215 can be disposed between the top submodule 220 and the bottom submodule 225. For example, one thermal component 215 can be configured for heat exchange with one battery module 115. The thermal component 215 can be disposed or thermally coupled between the top submodule 220 and the bottom submodule 225. One thermal component 215 can also be thermally coupled with more than one battery module 115 (or more than two submodules 220, 225). The battery submodules 220, 225 can collectively form one battery module 115. In some examples each submodule 220, 225 can be considered as a complete battery module 115, rather than a submodule.

The battery modules 115 can each include a plurality of battery cells 120. The battery modules 115 can be disposed within the housing 205 of the battery pack 110. The battery modules 115 can include battery cells 120 that are cylindrical cells, prismatic cells, or pouch cells, for example. The battery module 115 can operate as a modular unit of battery cells 120. For example, a battery module 115 can collect current or electrical power from the battery cells 120 that are included in the battery module 115 and can provide the current or electrical power as output from the battery pack 110. The battery pack 110 can include any number of battery modules 115. For example, the battery pack can have one, two, three, four, five, six, seven, eight, nine, ten, eleven, twelve or other number of battery modules 115 disposed in the housing 205. It should also be noted that each battery module 115 may include a top submodule 220 and a bottom submodule 225, possibly with a thermal component 215 in between the top submodule 220 and the bottom submodule 225. The battery pack 110 can include or define a plurality of areas for positioning of the battery module 115. The battery modules 115 can be square, rectangular, circular, triangular, symmetrical, or asymmetrical. In some examples, battery modules 115 may be different shapes, such that some battery modules 115 are rectangular but other battery modules 115 are square shaped, among other possibilities. The battery module 115 can include or define a plurality of slots, holders, or containers for a plurality of battery cells 120.

Battery cells 120 have a variety of form factors, shapes, or sizes. For example, battery cells 120 can have a cylindrical, rectangular, square, cubic, flat, or prismatic form factor. Battery cells 120 can be assembled, for example, by inserting a winded or stacked electrode roll (e.g., a jelly roll) including electrolyte material into at least one battery cell housing 230. The electrolyte material, e.g., an ionically conductive fluid or other material, can generate or provide electric power for the battery cell 120. A first portion of the electrolyte material can have a first polarity, and a second portion of the electrolyte material can have a second polarity. The housing 230 can be of various shapes, including cylindrical or rectangular, for example. Electrical connections can be made between the electrolyte material and components of the battery cell 120. For example, electrical connections with at least some of the electrolyte material can be formed at two points or areas of the battery cell 120, for example to form a first polarity terminal 235 (e.g., a positive or anode terminal) and a second polarity terminal 240 (e.g., a negative or cathode terminal). The polarity terminals can be made from electrically conductive materials to carry electrical current from the battery cell 120 to an electrical load, such as a component or system of the electric vehicle 105.

For example, the battery cell 120 can include lithium-ion battery cells. In lithium-ion battery cells, lithium ions can transfer between a positive electrode and a negative electrode during charging and discharging of the battery cell. For example, the battery cell anode can include lithium or graphite, and the battery cell cathode can include a lithium-based oxide material. The electrolyte material can be disposed in the battery cell 120 to separate the anode and cathode from each other and to facilitate transfer of lithium ions between the anode and cathode. It should be noted that battery cell 120 can also take the form of a solid state battery cell developed using solid electrodes and solid electrolytes. Yet further, some battery cells 120 can be solid state battery cells and other battery cells 120 can include liquid electrolytes for lithium-ion battery cells.

The battery cell 120 can be included in battery modules 115 or battery packs 110 to power components of the electric vehicle 105. The battery cell housing 230 can be disposed in the battery module 115, the battery pack 110, or a battery array installed in the electric vehicle 105. The housing 230 can be of any shape, such as cylindrical with a circular (e.g., as depicted), elliptical, or ovular base, among others. The shape of the housing 230 can also be prismatic with a polygonal base, such as a triangle, a square, a rectangle, a pentagon, and a hexagon, among others. The housing 230 can be rigid or not rigid (e.g., flexible).

The housing 230 of the battery cell 120 can include one or more materials with various electrical conductivity or thermal conductivity, or a combination thereof. The electrically conductive and thermally conductive material for the housing 230 of the battery cell 120 can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. The electrically insulative and thermally conductive material for the housing 230 of the battery cell 120 can include a ceramic material (e.g., silicon nitride, silicon carbide, titanium carbide, zirconium dioxide, beryllium oxide, and among others) and a thermoplastic material (e.g., polyethylene, polypropylene, polystyrene, polyvinyl chloride, or nylon), among others.

The battery cell 120 can include at least one anode layer 245, at least one cathode layer 255, and an electrolyte layer 260 disposed within the cavity 250 defined by the housing 230. The anode layer 245 can receive electrical current into the battery cell 120 and output electrons during the operation of the battery cell 120 (e.g., charging or discharging of the battery cell 120). The anode layer 245 can include an active substance. The active substance can include, for example, an activated carbon or a material infused with conductive materials (e.g., artificial or natural Graphite, or blended), lithium titanate (Li₄Ti₅O₁₂), or a silicon-based material (e.g., silicon metal, oxide, carbide, pre-lithiated).

FIGS. 7A, 7B, and 7C are illustrative cross-sectional views of various battery cells 120. The battery cell 120 can be, or include, a prismatic battery cell 120 (FIG. 7B). The prismatic battery cell 120 can have a housing 230 that defines a rigid enclosure. The housing 230 can have a polygonal base, such as a triangle, square, rectangle, pentagon, among others. For example, the housing 230 of the prismatic battery cell 120 can define a rectangular box. The prismatic battery cell 120 can include at least one anode layer 245, at least one cathode layer 255, and at least one electrolyte layer 260 disposed within the housing 230. The prismatic battery cell 120 can include a plurality of anode layers 245, cathode layers 255, and electrolyte layers 260. For example, the layers 245, 255, 260 can be stacked or in a form of a flattened spiral. The prismatic battery cell 120 can include an anode tab 265. The anode tab 265 can contact the anode layer 245 and facilitate energy transfer between the prismatic battery cell 120 and an external component. For example, the anode tab 265 can exit the housing 230 or electrically couple with a positive terminal 235 to transfer energy between the prismatic battery cell 120 and an external component.

The prismatic battery cell 120 (FIG. 7B) can also include a pressure vent 270. The pressure vent 270 can be disposed in the housing 230. The pressure vent 270 can provide pressure relief to the prismatic battery cell 120 as pressure increases within the prismatic battery cell 120. For example, gases can build up within the housing 230 of the prismatic battery cell 120. The pressure vent 270 can provide a path for the gases to exit the housing 230 when the pressure within the prismatic battery cell 120 reaches a threshold.

The present invention, thus generally described, will be understood more readily by reference to the following examples, which are provided by way of illustration and are not intended to be limiting of the present invention.

### Examples

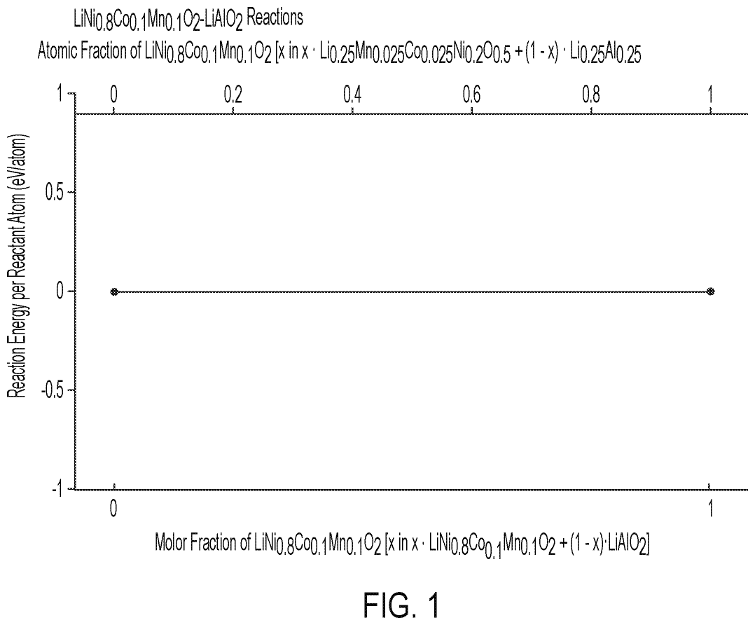

First-principles density functional theory (DFT) methodologies were used to model the stability of LiAlO₂ and LiNi_{0.8}Mn_{0.1}Co_{0.1}O₂ (NMC811) cathode materials. In particular, the interface app in materialproject.org, an open access materials database that is open to public was used to conduct the analysis. FIG. 1 is the calculated reaction energy v. molar fraction for a chemical reaction between NMC811 and LiAlO₂. The graph illustrates a straight line between the molar fraction x=0 to x=1 with zero reaction energy per atom (i.e., y=0 eV/atom), thereby clearly demonstrating that if LiAlO₂ were to be incorporated as a NMC811 cathode coating, the two materials would not react. In other words, LiAlO₂ was determined to be a stable coating for NMC811.

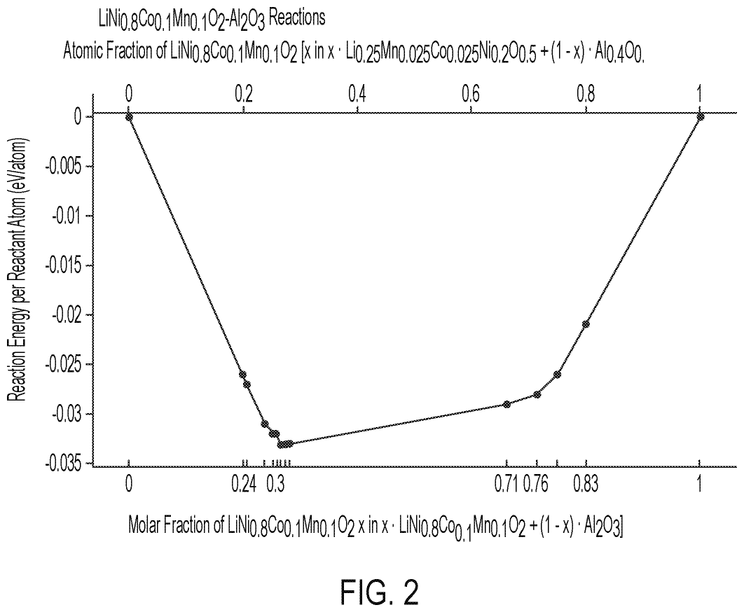

In comparison, a coating of Al₂O₃ is readily predicted to react with NMC811. As illustrated in FIG. 2, a similar calculation was conducted, and unlike LiAlO₂, Al₂O₃ will react with NMC811 cathode material, where the most energetically favorable chemical reaction is:

0.319LiNi_{0.8}Mn_{0.1}Co_{0.1}O₂+0.681Al₂O₃→0.082Ni₃O₄+0.006Li₄MnCo₅O₁₂+0.003LiO₈+0.273LiAl₅O₈+0.008Li₂Mn₃NiO₈

This reaction is calculated to proceed with an Eᵣₓₙ of −0.033 eV/atom. This indicates that while Al₂O₃ is commonly used as a coating for NMC811 cathode, it will consume lithium ions from NMC811 cathodes (i.e., less lithium ions are available for battery capacity). At the same time, Al₂O₃ itself decomposes to other stable phase mixtures that can lead to changes in coating morphology and volume changes. In other words, although commercially used to date, Al₂O₃ is not efficient as a coating.

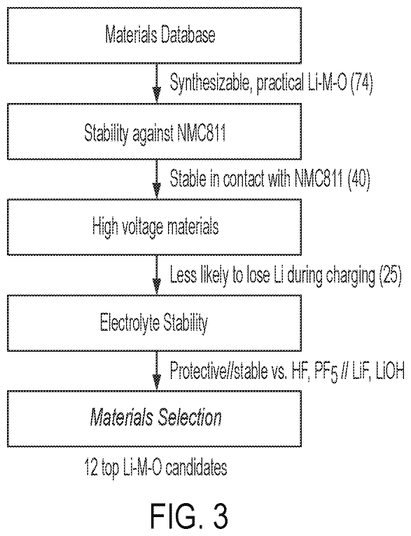

Following, are the results of a screening of 74 stable LiₓM_{y}O_{z} compounds as potential coating materials for NMC811 cathode materials. Of the 74, 40 LiₓM_{y}O_{z} compounds were found to be stable toward the NMC811. The methodology used in the screening is described in FIG. 3.

NMC811 cathode stability. The chemical stability of various LiₓM_{y}O_{z} compounds was tested against NMC811 in simulated environments (as discussed above), and the results are presented below. As illustrated in Table 1, a number of LiₓM_{y}O_{z} compounds were found unreactive toward NMC811. Several additional compounds have a predicted reaction enthalpy of near zero (i.e., 0>Eᵣₓₙ>−0.005 eV/atom): Li₃CrO₄, Li₂FeO₃, Li₁₉Ni₂₃O₄₂, LiYO₂, Li₅SbO₅, and Li₂CeO₃.

TABLE 1
Calculated Chemical stability with NMC811.

| Compounds | Interfacial Reactions | Eᵣₓₙ |
|---|---|---|
| LiAlO₂ | No Reaction | N/A |
| LiAl₅O₈ | 0.83 LiMn_{0.1}Co_{0.1}Ni_{0.8}O₂ + 0.17 LiAl₅O₈ → 0.017 | −0.015 |
| | Li₄MnCo₅O₁₂ + 0.038 LiO₈ + 0.022 Li₂Mn₃NiO₈ + 0.852 | |
| | LiAlO₂ + 0.642 NiO | |
| Li₅AlO₄ | No Reaction | N/A |
| Li₂Si₂O₅ | 0.291 Li₂Si₂O₅ + 0.709 LiMn_{0.1}Co_{0.1}Ni_{0.8}O₂ → 0.014 | −0.019 |
| | Li₄MnCo₅O₁₂ + 0.019 Li₂Mn₃NiO₈ + 0.032 LiO₈ + 0.582 | |
| | Li₂SiO₃ + 0.548 NiO | |
| Li₄SiO₄ | No reaction | N/A |
| Li₂SiO₃ | No reaction | N/A |
| LiScO₂ | No reaction | N/A |
| Li₄Ti₅O₁₂ | 0.171 Li₄Ti₅O₁₂ + 0.829 LiMn_{0.1}Co_{0.1}Ni_{0.8}O₂ → 0.017 | −0.018 |
| | Li₄MnCo₅O₁₂ + 0.043 Ti₄(Ni₅O₈)₃ + 0.032 LiO₈ + 0.686 | |
| | Li2TiO₃ + 0.022 Li₂Mn₃NiO₈ | |
| LiTiO₂ | 0.7 LiTiO₂ + 0.3 LiMn_{0.1}Co_{0.1}Ni_{0.8}O₂ → 0.03 Li₂Ti₃CoO₈ + | −0.273 |
| | 0.4 Li₂TiO₃ + 0.04 Li₂Mn₃NiO₈ + 0.03 Li₂Ti₃MnO₈ + 0.2 | |
| | Ni | |
| Li₄TiO₄ | No Reaction | N/A |
| Li₇Ti₁₁O₂₄ | 0.211 Li₇Ti₁₁O₂₄ + 0.789 LiMn_{0.1}Co_{0.1}Ni_{0.8}O₂ → 0.079 | −0.109 |
| | Li₂Ti₃CoO₈ + 0.5 Li₂TiO₃ + 0.526 Li₂Ti₃NiO₈ + 0.026 | |
| | Li₂Mn₃NiO₈ + 0.079 NiO | |
| Li₂TiO₃ | No Reaction | N/A |
| LiTi₂O₄ | 0.5 LiTi2O4 + 0.5 LiMn_{0.1}Co_{0.1}Ni_{0.8}O₂ → 0.05 | −0.177 |
| | Li₂Ti₃CoO₈ + 0.25 Li₂TiO₃ + 0.15 Li₂Ti₃NiO₈ + 0.05 | |
| | Li₂Ti₃MnO₈ + 0.25 NiO | |
| LiVO₃ | 0.692 LiMn_{0.1}Co_{0.1}Ni_{0.8}O₂ + 0.308 LiVO₃ → 0.074 Ni₃O₄ + | −0.054 |
| | 0.022 LiO₈ + 0.014 Li₄MnCo₅O₁₂ + 0.055 Mn(Ni3O4)2 + | |
| | 0.308 Li₃VO₄ | |
| Li₃VO₄ | No Reaction | N/A |
| LiV₂O₅ | 0.674 LiMn_{0.1}Co_{0.1}Ni_{0.8}O₂ + 0.326 LiV₂O₅ → 0.013 | −0.105 |
| | Li₄MnCo₅O₁₂ + 0.174 V₂Ni₃O₈ + 0.018 Li₂Mn₃NiO₈ + | |
| | 0.303 Li₃VO₄ + 0.033 O₂ | |
| LiVO₂ | 0.69 LiMn_{0.1}Co_{0.1}Ni_{0.8}O₂ + 0.31 LiVO₂ → 0.069 CoO + | −0.194 |
| | 0.069 LiMnO₂ + 0.31 Li₃VO₄ + 0.552 NiO | |
| Li₂CrO₄ | No Reaction | N/A |
| Li₃CrO₄ | 0.991 LiMn_{0.1}Co_{0.1}Ni_{0.8}O₂ + 0.009 Li₃CrO₄ → 0.075 | −0.001 |
| | Li₁₀CoNi₉O₂₀ + 0.009 Li₂₄Mn₁₁CrO₃₆ + 0.024 Li₂CoO₃ + | |
| | 0.114 NiO | |
| LiCr₃O₈ | 0.815 LiMn_{0.1}Co_{0.1}Ni_{0.8}O₂ + 0.185 LiCr₃O₈ → 0.016 | −0.093 |
| | Li₄MnCo₅O₁₂ + 0.065 Mn(Ni₃O₄)₂ + 0.087 CrNiO₄ + 0.467 | |
| | Li₂CrO₄ + 0.174 NiO | |
| LiCrO₂ | 0.714 LiMn_{0.1}Co_{0.1}Ni_{0.8}O₂ + 0.286 LiCrO₂ → 0.071 | −0.046 |
| | LiCoO₂ + 0.071 Li₄MnCrO₆ + 0.214 Li₃CrO₄ + 0.571 NiO | |
| Li₂MnO₃ | No Reaction | N/A |
| Li₄Mn₅O₁₂ | 0.605 LiMn_{0.1}Co_{0.1}Ni_{0.8}O₂ + 0.395 Li₄Mn₅O₁₂ → 0.027 | −0.028 |
| | LiO₈ + 0.484 Li₂Mn₃NiO₈ + 0.012 Li₄MnCo₅O₁₂ + 0.57 | |
| | Li₂MnO₃ | |
| Li₅Mn₇O₁₆ | 0.695 LiMn_{0.1}Co_{0.1}Ni_{0.8}O₂ + 0.305 Li₅Mn₇O₁₆ → 0.011 | −0.038 |
| | LiO₈ + 0.556 Li₂Mn₃NiO₈ + 0.014 Li₄MnCo₅O₁₂ + 0.52 | |
| | Li₂MnO₃ | |
| LiMn₂O₄ | 0.595 LiMn_{0.1}Co_{0.1}Ni_{0.8}O₂ + 0.405 LiMn₂O₄ → 0.19 | −0.073 |
| | Li₂Mn₃NiO₈ + 0.012 Li4MnCo₅O₁₂ + 0.286 Li₂MnO₃ + | |
| | 0.286 NiO | |
| LiMnO₂ | 0.588 LiMn_{0.1}Co_{0.1}Ni_{0.8}O₂ + 0.412 LiMnO₂ → 0.059 | −0.089 |
| | LiCoO₂ + 0.471 Li₂MnO₃ + 0.471 NiO | |
| Li₅Mn₇O₁₆ | 0.667 LiMn_{0.1}Co_{0.1}Ni_{0.8}O₂ + 0.333 Li₅Mn₇O₁₆ → 0.12 | −0.037 |
| | Li₉Mn₁₂Ni₃O₃₂ + 0.173 Li₂Mn₃NiO₈ + 0.013 Li₄MnCo₅O₁₂ + | |
| | 0.427 Li₂MnO₃ | |
| Li₆MnO₄ | 0.741 LiMn_{0.1}Co_{0.1}Ni_{0.8}O₂ + 0.259 Li₆MnO₄ → 0.074 | −0.085 |
| | LiCoO₂ + 0.333 Li₂MnO₃ + 0.778 Li₂O + 0.593 NiO | |
| LiFeO₂ | No Reaction | N/A |
| Li₂FeO₃ | 0.5 LiMn_{0.1}Co_{0.1}Ni_{0.8}O₂ + 0.5 Li₂FeO₃ → 0.5 LiFeO₂ + 0.4 | −0.003 |
| | Li₂NiO₃ + 0.05 Li₂CoO₃ + 0.05 Li₂MnO₃ | |
| Li₅FeO₄ | No Reaction | N/A |
| Li₆CoO₄ | 0.588 LiMn_{0.1}Co_{0.1}Ni_{0.8}O₂ + 0.412 Li₆CoO₄ → 0.471 | −0.038 |
| | LiCoO₂ + 0.059 Li₂MnO₃ + 1.235 Li₂O + 0.471 NiO | |
| Li₂CoO₃ | No Reaction | N/A |
| Li₁₀Co₄O₉ | 0.851 LiMn_{0.1}Co_{0.1}Ni_{0.8}O₂ + 0.149 Li₁₀Co₄O₉ → 0.681 | −0.058 |
| | LiCoO₂ + 0.085 Li₂MnO₃ + 0.745 Li₂O + 0.681 NiO | |
| LiCoO₂ | 0.625 LiMn_{0.1}Co_{0.1}Ni_{0.8}O₂ + 0.375 LiCoO₂ → 0.438 | −0.011 |
| | Li₂CoO₃ + 0.063 Li₂MnO₃ + 0.5 NiO | |
| LiCo₂O₄ | 0.625 LiMn_{0.1}Co_{0.1}Ni_{0.8}O₂ + 0.375 Li(CoO₂)₂ → 0.25 | −0.011 |
| | LiCoNiO₄ + 0.063 Li₄MnCo₅O₁₂ + 0.25 Li₂CoO₃ + 0.25 | |
| | NiO | |
| Li₄₇Co₈O₃₂ | 0.909 LiMn_{0.1}Co_{0.1}Ni_{0.8}O₂ + 0.091 Li₄₇(CoO₄)₈ → 0.818 | −0.035 |
| | LiCoO₂ + 0.091 Li₂MnO₃ + 2.091 Li₂O + 0.727 NiO | |
| LiNi₂O₄ | No Reaction | N/A |
| LiNiO₂ | No Reaction | N/A |
| Li₅NiO₄ | No Reaction | N/A |
| Li₁₉Ni₂₃O₄₂ | No Reaction | N/A |
| Li₂NiO₃ | 0.909 LiMn_{0.1}Co_{0.1}Ni_{0.8}O₂ + 0.091 Li₂NiO₃ → 0.091 | −0.001 |
| | Li₁₀CoNi₉O₂₀ + 0.091 Li₂MnO₃ | |
| LiCuO | 0.741 LiMn_{0.1}Co_{0.1}Ni_{0.8}O₂ + 0.259 LiCuO → 0.259 | −0.07 |
| | Li₃CuO₃ + 0.074 LiCoO₂ + 0.074 Li₂MnO₃ + 0.593 NiO | |
| LiCuO₂ | No Reaction | N/A |
| Li₃CuO₃ | No Reaction | N/A |
| Li₆ZnO₄ | No Reaction | N/A |
| Li₁₀Zn₄O₉ | No Reaction | N/A |
| LiYO₂ | 0.294 LiMn_{0.1}Co_{0.1}Ni_{0.8}O₂ + 0.706 LiYO₂ → 0.176 | −0.003 |
| | Li₅NiO₄ + 0.029 Li₂CoO₃ + 0.029 Li₂MnO₃ + 0.353 Y₂O₃ + | |
| | 0.059 NiO | |
| Li₂ZrO₃ | No Reaction | N/A |
| Li₆Zr₂O7 | No Reaction | N/A |
| Li₈Nb₂O₉ | No Reaction | N/A |
| LiNbO₃ | 0.758 LiMn_{0.1}Co_{0.1}Ni_{0.8}O₂ + 0.242 LiNbO₃ → 0.172 | −0.011 |
| | Li(NiO₂)₂ + 0.015 Li₄MnCo₅O₁₂ + 0.02 Li₂Mn₃NiO₈ + | |
| | 0.242 Li₃NbO₄ + 0.242 NiO | |
| Li₃NbO₄ | No Reaction | N/A |
| LiNbO₂ | 0.417 LiMn_{0.1}Co_{0.1}Ni_{0.8}O₂ + 0.583 LiNbO₂ → 0.333 | −0.294 |
| | LiNbO₃ + 0.042 LiMnNbO4 + 0.014 Co3Ni + 0.208 | |
| | Li₃NbO₄ + 0.319 Ni | |
| LiNb₃O₈ | 0.692 LiMn_{0.1}Co_{0.1}Ni_{0.8}O₂ + 0.308 LiNb₃O₈ → 0.074 Ni₃O₄ + | −0.029 |
| | 0.923 LiNbO₃ + 0.014 Li₄MnCo₅O₁₂ + 0.055 Mn(Ni₃O₄)₂ + | |
| | 0.022 LiO₈ | |
| Li₄MoO₅ | No Reaction | N/A |
| Li₂MoO₄ | No Reaction | N/A |
| Li₂MoO₃ | 0.69 LiMn_{0.1}Co_{0.1}Ni_{0.8}O₂ + 0.31 Li₂MoO₃ → 0.552 NiO + | −0.147 |
| | 0.31 Li₄MoO₅ + 0.069 LiMnO₂ + 0.069 CoO | |
| Li₂SnO₃ | No Reaction | N/A |
| Li₈SnO₆ | No Reaction | N/A |
| Li₅SbO₅ | 0.182 Li₅SbO₅ + 0.818 LiMn_{0.1}Co_{0.1}Ni_{0.8}O₂ → 0.091 | −0.004 |
| | Li₅NiO₄ + 0.182 Li₃Ni₂SbO₆ + 0.2 Li₂NiO₃ + 0.082 | |
| | Li₂CoO₃ + 0.082 Li₂MnO₃ | |
| Li₃SbO₄ | 0.2 Li₃SbO₄ + 0.8 LiMn_{0.1}Co_{0.1}Ni_{0.8}O₂ → 0.2 Li₃Ni₂SbO₆ + | −0.014 |
| | 0.24 Li₂NiO₃ + 0.08 Li₂CoO₃ + 0.08 Li2MnO3 | |
| LiSb₃O₈ | 0.291 LiSb₃O₈ + 0.709 LiMn_{0.1}Co_{0.1}Ni_{0.8}O₂ → 0.548 | −0.066 |
| | LiNiSbO₄ + 0.032 LiO₈ + 0.019 Li₂Mn₃NiO₈ + 0.014 | |
| | Li₄MnCo₅O₁₂ + 0.325 LiSbO₃ | |
| LiSbO₂ | 0.31 LiSbO₂ + 0.69 LiMn_{0.1}Co_{0.1}Ni_{0.8}O₂ → 0.276 | −0.197 |
| | Li₃Ni₂SbO₆ + 0.034 Li₃SbO₄ + 0.069 LiMnO₂ + 0.069 CoO | |
| LiSbO₃ | 0.281 LiSbO₃ + 0.719 LiMn_{0.1}Co_{0.1}Ni_{0.8}O₂ → 0.033 LiO₈ + | −0.027 |
| | 0.281 Li₃Ni₂SbO₆ + 0.012 Li₂Mn₃NiO₈ + 0.014 | |
| | Li₄MnCo₅O₁₂ + 0.021 Li₂MnO₃ | |
| Li₂CeO₃ | 0.455 LiMn_{0.1}Co_{0.1}Ni_{0.8}O₂ + 0.545 Li₂CeO₃ → 0.273 | −0.003 |
| | Li₅NiO₄ + 0.045 Li₂CoO₃ + 0.545 CeO₂ + 0.045 Li₂MnO₃ + | |
| | 0.091 NiO | |
| Li₄WO₅ | No Reaction | N/A |
| Li₂WO₄ | 0.758 LiMn_{0.1}Co_{0.1}Ni_{0.8}O₂ + 0.242 Li₂WO₄ → 0.172 | −0.01 |
| | Li(NiO₂)₂ + 0.015 Li₄MnCo₅O₁₂ + 0.242 NiO + 0.02 | |
| | Li₂Mn₃NiO₈ + 0.242 Li₄WO₅ | |
| LiBiO₂ | 0.741 LiMn_{0.1}Co_{0.1}Ni_{0.8}O₂ + 0.259 LiBiO₂ → 0.074 | −0.036 |
| | LiCoO₂ + 0.259 Li₃BiO₄ + 0.074 Li₂MnO₃ + 0.593 NiO | |
| Li₃BiO₃ | 0.741 LiMn_{0.1}Co_{0.1}Ni_{0.8}O₂ + 0.259 Li₃BiO₃ → 0.259 | −0.024 |
| | Li₅BiO₅ + 0.074 LiCoO₂ + 0.074 Li₂MnO₃ + 0.593 NiO | |
| Li₅BiO₅ | No Reaction | N/A |
| LiBiO₃ | No Reaction | N/A |
| Li₃BiO₄ | No Reaction | N/A |
| Li₇BiO₆ | No Reaction | N/A |

Voltage screening for LiₓM_{y}O_{z}. Voltage values for Li-M-O compounds were determined for the compounds in Table 1. Table 2 summarizes the analysis of the approximate voltage value and metal oxidation state. Higher voltages are desired, and in determining the voltage, 3.0 V vs. Li/Li⁺, was used as a lower limit.

TABLE 2
Voltage and oxidation state analysis for LiₓM_{y}O_{z} compounds that
are stable with NMC811. LiₓM_{y}O_{z} that are anode materials, or which
had a voltage of less than 3 V vs. Li/Li⁺ were eliminated.

| | Approximate Voltage | Metal oxidation |
|---|---|---|
| Compounds | (V vs. Li/Li⁺) | state |
| LiAlO₂ | ~4 | 3+ |
| Li₅AlO₄ | ~4 | 3+ |
| Li₄SiO₄ | Anode | 4+ |
| Li₂SiO₃ | Anode | 4+ |
| LiScO₂ | 3.5 | 3+ |
| Li₄TiO₄ | ~4 | 4+ |
| Li₂TiO₃ | 4.5 | 4+ |
| Li₃VO₄ | Anode | 5+ |
| Li₂CrO₄ | 2.92 | 6+ |
| Li₃CrO₄ | 2.92 | 5+ |
| Li₂MnO₃ | 4.62 | 4+ |
| LiFeO₂ | 4.22 | 3+ |
| Li₂FeO₃ | 4.12 | 4+ |
| Li₅FeO₄ | 3.7 | 3+ |
| Li₂CoO₃ | 4.1 | 4+ |
| LiNi₂O₄ | 3.02 | 3.5+ |
| LiNiO₂ | 3.02 | 3+ |
| Li₅NiO₄ | 2.65 | 3+ |
| Li₁₉Ni₂₃O₄₂ | ~2.5 | 2.8+ |
| Li₂NiO₃ | 4.6 | 4+ |
| LiCuO₂ | 4.58 | 3+ |
| Li₃CuO₃ | ~4 | 3+ |
| Li₆ZnO₄ | 2.9 | 2+ |
| Li₁₀Zn₄O₉ | 2.9 | 2+ |
| LiYO₂ | ~3 | 3+ |
| Li₂ZrO₃ | 4.2 | 4+ |
| Li₆Zr₂O₇ | ~4 | 4+ |
| Li₈Nb₂O₉ | N/A | 5+ |
| Li₃NbO₄ | 3.3 | 5+ |
| Li₄MoO₅ | ~4 | 6+ |
| Li₂MoO₄ | ~4 | 6+ |
| Li₂SnO₃ | 4.66 | 4+ |
| Li₈SnO₆ | ~4 | 4+ |
| Li₅SbO₅ | 3 | 5+ |
| Li₂CeO₃ | Anode | 4+ |
| Li₄WO₅ | Anode | 4+ |
| Li₅BiO₅ | 1.2 | 5+ |
| LiBiO₃ | 1.4 | 5+ |
| Li₃BiO₄ | 1.2 | 5+ |
| Li₇BiO₆ | 1.2 | 5+ |

Chemical reactivity against HF. HF is a known contaminant in LIB electrolytes, being formed when residual water/moisture is present to react with electrolyte salts such as LiPF₆: LiPF₆+H₂O↔POF₃+2HF+LiF. NMC811 can react with HF in the reactions illustrated in Table 3, where it is shown that at all ratios of the compounds, decomposition is predicted.

TABLE 3
NMC811 cathode decomposition reactions by HF attack.

| Molar | | Eᵣₓₙ |
|---|---|---|
| fraction | Chemical reactions | [eV/atom] |
| 0.083 | 0.083 Li₁Mn_{0.1}Co_{0.1}Ni_{0.8}O₂ + 0.917 HF → 0.139 H₆OF₄ + 0.083 LiHF₂ + | −0.192 |
| | 0.008 CoF₃ + 0.066 NiF₂ + 0.004 Mn₂O₂F₉ + 0.009 O₂ | |
| 0.085 | 0.085 Li₁Mn_{0.1}Co_{0.1}Ni_{0.8}O₂ + 0.915 HF → 0.141 H₆OF₄ + 0.009 Li₂MnF₆ + | −0.197 |
| | 0.068 LiHF₂ + 0.009 CoF₃ + 0.068 NiF₂ + 0.015 O₂ | |
| 0.119 | 0.119 Li₁Mn_{0.1}Co_{0.1}Ni_{0.8}O₂ + 0.881 HF → 0.196 H₄OF₂ + 0.012 Li₂MnF₆ + | −0.228 |
| | 0.095 LiHF₂ + 0.012 CoF₃ + 0.095 NiF₂ + 0.021 O₂ | |
| 0.122 | 0.122 Li₁Mn_{0.1}Co_{0.1}Ni_{0.8}O₂ + 0.878 HF → 0.195 H₄OF₂+ 0.012 Li₂MnF₆ + | −0.230 |
| | 0.098 LiHF₂ + 0.012 CoF₂ + 0.098 NiF₂ + 0.024 O₂ | |
| 0.152 | 0.152 Li₁Mn_{0.1}Co_{0.1}Ni_{0.8}O₂ + 0.848 HF → 0.242 H₃OF + 0.015 Li₂MnF₆ + | −0.253 |
| | 0.121 LiHF₂ + 0.015 CoF₂ + 0.121 NiF₂ + 0.03 O₂ | |
| 0.153 | 0.153 Li₁Mn_{0.1}Co_{0.1}Ni_{0.8}O₂ + 0.847 HF → 0.015 LiMnF₄ + 0.237 H₃OF + | −0.253 |
| | 0.137 LiHF₂ + 0.015 CoF₂ + 0.122 NiF₂ + 0.034 O₂ | |
| 0.155 | 0.155 Li₁Mn_{0.1}Co_{0.1}Ni_{0.8}O₂ + 0.845 HF → 0.016 Li₂MnF₅ + 0.24 H₃OF + | −0.254 |
| | 0.124 LiHF₂ + 0.016 CoF₂ + 0.124 NiF₂ + 0.035 O₂ | |
| 0.177 | 0.177 Li₁Mn_{0.1}Co_{0.1}Ni_{0.8}O₂ + 0.823 HF → 0.071 Li₂NiF₄ + 0.018 Li₂MnF₅ + | −0.260 |
| | 0.274 H₃OF + 0.018 CoF₂ + 0.071 NiF₂ + 0.04 O₂ | |
| 0.189 | 0.189 Li₁Mn_{0.1}Co_{0.1}Ni_{0.8}O₂ + 0.811 HF → 0.075 Li₂NiF₄ + 0.019 Li₂MnF₅ + | −0.262 |
| | 0.264 H₃OF + 0.019 CoHO₂ + 0.075 NiF₂ + 0.038 O₂ | |
| 0.256 | 0.256 Li₁Mn_{0.1}Co_{0.1}Ni_{0.8}O₂ + 0.744 HF → 0.103 Li₂NiF₄ + 0.026 Li₂MnF₅ + | −0.272 |
| | 0.026 CoHO₂ + 0.359 H₂O + 0.103 NiF₂ + 0.051 O₂ | |
| 0.278 | 0.278 Li₁Mn_{0.1}Co_{0.1}Ni_{0.8}O₂ + 0.722 HF → 0.139 Li₂NiF₄ + 0.028 CoHO₂ + | −0.274 |
| | 0.347 H₂O + 0.028 MnO₂ + 0.083 NiF₂ + 0.049 O₂ | |
| 0.294 | 0.294 Li₁Mn_{0.1}Co_{0.1}Ni_{0.8}O₂ + 0.706 HF → 0.147 Li₂NiF₄ + 0.029 MnNiO₃ + | −0.271 |
| | 0.029 CoHO₂ + 0.338 H₂O + 0.059 NiF₂ + 0.051 O₂ | |
| 0.333 | 0.333 Li₁Mn_{0.1}Co_{0.1}Ni_{0.8}O₂ + 0.667 HF → 0.167 Li₂NiF₄ + 0.02 MnNiO₃ + | −0.259 |
| | 0.033 CoHO₂ + 0.013 Mn(Ni₃O₄)₂ + 0.317 H₂O + 0.058 O₂ | |
| 0.417 | 0.417 Li₁Mn_{0.1}Co_{0.1}Ni_{0.8}O₂ + 0.583 HF → 0.083 Li₂NiF₄ + 0.042 CoHO₂ + | −0.234 |
| | 0.042 Mn(Ni₃O₄)₂ + 0.271 H₂O + 0.25 LiF + 0.073 O₂ | |
| 0.500 | 0.5 Li₁Mn_{0.1}Co_{0.1}Ni_{0.8}O₂ + 0.5 HF → 0.033 Ni₃O₄ + 0.05 CoHO₂ + 0.05 | −0.210 |
| | Mn(Ni₃O₄)₂ + 0.225 H₂O + 0.5 LiF + 0.071 O₂ | |
| 0.513 | 0.513 Li₁Mn_{0.1}Co_{0.1}Ni_{0.8}O₂ + 0.487 HF → 0.026 Li(CoO₂)₂ + 0.034 Ni₃O₄ + | −0.206 |
| | 0.051 Mn(Ni₃O₄)₂ + 0.244 H₂O + 0.487 LiF + 0.066 O₂ | |
| 0.521 | 0.521 Li₁Mn_{0.1}Co_{0.1}Ni_{0.8}O₂ + 0.479 HF → 0.01 Li₄MnCo₅O₁₂ + 0.056 Ni₃O₄ + | −0.204 |
| | 0.042 Mn(Ni₃O₄)₂ + 0.24 H₂O + 0.479 LiF + 0.061 O₂ | |
| 0.529 | 0.529 Li₁Mn_{0.1}Co_{0.1}Ni_{0.8}O₂ + 0.471 HF → 0.016 LiO₈ + 0.011 Li₄MnCo₅O₁₂ + | −0.200 |
| | 0.056 Ni₃O₄ + 0.042 Mn(Ni₃O₄)₂ + 0.235 H₂O + 0.471 LiF | |
| 0.539 | 0.539 Li₁Mn_{0.1}Co_{0.1}Ni_{0.8}O₂ + 0.461 HF → 0.006 LiO₈ + 0.011 Li₄MnCo₅O₁₂ + | −0.196 |
| | 0.014 Li₂Mn₃NiO₈ + 0.139 Ni₃O₄ + 0.231 H₂O + 0.461 LiF | |
| 0.549 | 0.549 Li₁Mn_{0.1}Co_{0.1}Ni_{0.8}O₂ + 0.451 HF → 0.025 LiO₈ + 0.011 Li₄MnCo₅O₁₂ + | −0.191 |
| | 0.015 Li₂Mn₃NiO₈ + 0.425 NiO + 0.225 H₂O + 0.451 LiF | |
| 0.610 | 0.61 Li₁Mn_{0.1}Co_{0.1}Ni_{0.8}O₂ + 0.39 HF → 0.138 Li(NiO₂)₂ + 0.012 | −0.163 |
| | Li₄MnCo₅O₁₂ + 0.016 Li₂Mn₃NiO₈ + 0.195 NiO + 0.195 H₂O + 0.39 LiF | |
| 0.652 | 0.652 Li₁Mn_{0.1}Co_{0.1}Ni_{0.8}O₂ + 0.348 HF → 0.148 Li(NiO₂)₂ + 0.013 | −0.143 |
| | Li₄MnCo₅O₁₂ + 0.226 NiO + 0.174 H₂O + 0.052 Li₂MnO₃ + 0.348 LiF | |
| 0.714 | 0.714 Li₁Mn_{0.1}Co_{0.1}Ni_{0.8}O₂ + 0.286 HF → 0.143 Li(NiO₂)₂ + 0.071 Li2CoO₃ + | −0.114 |
| | 0.286 NiO + 0.143 H₂O + 0.071 Li₂MnO₃ + 0.286 LiF | |

Therefore, it would be beneficial for a Li-M-O coating candidate to scavenge HF as much as possible. Table 4 summarizes HF reactivity for Li-M-O materials screened from our previous step.

In Table 4, it is shown that 0.2 LiAlO₂ reacts with 0.8 HF to form 0.4 H₂O, 0.067 Li₃AlF₆, and 0.133 AlF₃ with −0.331 eV/atom. We would like a new Li-M-O coating to more effectively scavenge HF when compared to LiAlO₂. In other words, it would be beneficial when the ratio of HF:Li-M-O is high. For example, where HF:LiAlO₂ is about 0.8:0.2=4. All other Li-M-O materials were then normalized to LiAlO₂. For example, Li₅AlO₄ has a HF:Li₅AlO₄ of 8.01, and 4/8.01=0.5 in the next column (vs. LiAlO₂; i.e. 0.5 is “normalized” to LiAlO₂). It is beneficial when this value is less than 1 (i.e., more reactive against HF).

Another criteria used to evaluate potential coating candidates is the reaction enthalpy. For the reaction of LiAlO₂ with HF, the enthalpy of reaction (Eᵣₓₙ) is −0.311 eV/atom. This is then compared other materials vs. LiAlO₂ in the next column. For example, Li₅AlO₄ has an Eᵣₓₙ of −0.406 eV/atom; therefore, −0.311/−0.406=0.77 in the next column (vs. LiAlO₂; again “normalized” to LiAlO₂). Also, it is beneficial when this value is less than 1 (i.e., HF scavenging reaction is more favorable). The next column of Table 1, “sum,” adds the two values that are referenced to LiAlO₂ for molar ratio and reaction enthalpy. Since these values are evaluated based on the molar fraction, we then convert this value by dividing my molecular weight: e.g., 2.00/65.92×1,000=30.45 for LiAlO₂. Lastly, we provide the percentage improvement vs. LiAlO₂ for all materials: 30.45/10.17×100=301.3% for Li₅AlO₄. In Table 4, we observe that 23 Li-M-O compounds (except LiCuO₂) are calculated to exhibit an improved performance for HF scavenging reactions, when to compared with the state-of-art LiAlO₂ material.

TABLE 4
HF reactions with Li-M-O coating candidates.

| | | | | vs. | Eᵣₓₙ | vs. | | Per | HF |
|---|---|---|---|---|---|---|---|---|---|
| Compounds | MW | HF Reactions | Ratio | LiAlO₂ | (eV/atom) | LiAlO₂ | Sum | weight | score |
| LiAlO₂ | 65.92 | 0.8 HF + 0.2 LiAlO₂ → 0.4 H₂O + 0.067 | 4.00 | 1.00 | −0.311 | 1.00 | 2.00 | 30.34 | 100.0% |
| | | Li₃AlF₆ + 0.133 AlF₃ | | | | | | | |
| Li₅AlO₄ | 125.68 | 0.889 HF + 0.111 Li₅AlO₄ → 0.444 H₂O + | 8.01 | 0.50 | −0.406 | 0.77 | 1.27 | 10.07 | 301.3% |
| | | 0.111 Li₃AlF₆ + 0.222 LiF | | | | | | | |
| LiScO₂ | 83.9 | 0.8 HF + 0.2 LiScO₂ → 0.067 Li₃ScF₆ + 0.4 | 4.00 | 1.00 | −0.358 | 0.87 | 1.87 | 22.27 | 136.2% |
| | | H₂O + 0.133 ScF₃ | | | | | | | |
| Li₄TiO₄ | 139.63 | 0.111 Li₄TiO₄ + 0.889 HF → 0.111 Li₂TiF₆ + | 8.01 | 0.50 | −0.334 | 0.93 | 1.43 | 10.25 | 296.1% |
| | | 0.444 H₂O + 0.222 LiF | | | | | | | |
| Li₂TiO₃ | 109.75 | 0.143 Li₂TiO₃ + 0.857 HF → 0.143 Li₂TiF₆ + | 5.99 | 0.67 | −0.283 | 1.10 | 1.77 | 16.09 | 188.5% |
| | | 0.429 H₂O | | | | | | | |
| Li₂MnO₃ | 116.82 | 0.882 HF + 0.118 Li₂MnO₃ → 0.118 Li₂MnF₅ + | 7.47 | 0.54 | −0.224 | 1.39 | 1.92 | 16.47 | 184.3% |
| | | 0.294 H₃OF + 0.029 O₂ | | | | | | | |
| LiFeO₂ | 94.78 | 0.2 LiFeO₂ + 0.8 HF → 0.067 Li₃FeF₆ + 0.133 | 4.00 | 1.00 | −0.278 | 1.12 | 2.12 | 22.35 | 135.7% |
| | | FeF₃ + 0.4 H₂O | | | | | | | |
| Li₂FeO₃ | 117.73 | 0.167 Li₂FeO₃ + 0.833 HF → 0.111 Li₃FeF₆ + | 4.99 | 0.80 | −0.301 | 1.03 | 1.84 | 15.59 | 194.6% |
| | | 0.056 FeF₃ + 0.417 H₂O + 0.042 O₂ | | | | | | | |
| Li₅FeO₄ | 154.55 | 0.167 Li₅FeO₄ + 0.833 HF → 0.333 H₂O + | 4.99 | 0.80 | −0.398 | 0.78 | 1.58 | 10.24 | 296.1% |
| | | 0.833 LiF + 0.167 FeHO₂ | | | | | | | |
| Li₂CoO₃ | 120.81 | 0.667 HF + 0.333 Li₂CoO₃ → 0.167 H₂O + | 2.00 | 2.00 | −0.235 | 1.32 | 3.32 | 27.48 | 110.4% |
| | | 0.667 LiF + 0.333 CoHO₂ + 0.083 O₂ | | | | | | | |
| LiNi₂O₄ | 188.33 | 0.833 HF + 0.167 Li(NiO₂)₂ → 0.083 Li₂NiF₄ + | 4.99 | 0.80 | −0.257 | 1.21 | 2.01 | 10.68 | 284.0% |
| | | 0.417 H₂O + 0.25 NiF₂ + 0.125 O₂ | | | | | | | |
| LiNiO₂ | 97.63 | 0.75 HF + 0.25 LiNiO₂ → 0.125 Li2NiF₄ + | 3.00 | 1.33 | −0.292 | 1.07 | 2.40 | 24.57 | 123.5% |
| | | 0.375 H₂O + 0.125 NiF₂ + 0.062 O₂ | | | | | | | |
| Li₂NiO₃ | 120.57 | 0.8 HF + 0.2 Li₂NiO₃ → 0.2 Li₂NiF₄ + 0.4 | 4.00 | 1.00 | −0.307 | 1.01 | 2.01 | 16.70 | 181.7% |
| | | H₂O + 0.1 O₂ | | | | | | | |
| LiCuO₂ | 102.49 | 0.714 HF + 0.286 LiCuO₂ → 0.143 H₃OF + | 2.50 | 1.60 | −0.201 | 1.55 | 3.15 | 30.73 | 98.7% |
| | | 0.286 LiHF₂ + 0.143 Cu₂O₃ | | | | | | | |
| Li₃CuO₃ | 132.37 | 0.75 HF + 0.25 Li₃CuO₃ → 0.125 Cu₂O₃ + | 3.00 | 1.33 | −0.324 | 0.96 | 2.29 | 17.32 | 175.1% |
| | | 0.375 H₂O + 0.75 LiF | | | | | | | |
| LiYO₂ | 127.85 | 0.8 HF + 0.2 LiYO₂ → 0.2 LiYF₄ + 0.4 H₂O | 4.00 | 1.00 | −0.445 | 0.70 | 1.70 | 13.29 | 228.3% |
| Li₂ZrO₃ | 153.1 | 0.857 HF + 0.143 Li₂ZrO₃ → 0.143 Li₂ZrF₆ + | 5.99 | 0.67 | −0.338 | 0.92 | 1.59 | 10.37 | 292.6% |
| | | 0.429 H₂O | | | | | | | |
| Li₆Zr₂O₇ | 336.09 | 0.933 HF + 0.067 Li₆Zr₂O₇ → 0.067 Li₄ZrF₈ + | 13.93 | 0.29 | −0.359 | 0.87 | 1.15 | 3.43 | 884.0% |
| | | 0.067 Li₂ZrF₆ + 0.467 H₂O | | | | | | | |
| Li₈Nb₂O₉ | 385.34 | 0.091 Li8Nb₂O₉ + 0.909 HF → 0.182 | 9.99 | 0.40 | −0.286 | 1.09 | 1.49 | 3.86 | 785.8% |
| | | LiNb(OF)₂ + 0.455 H₂O + 0.545 LiF | | | | | | | |
| Li₃NbO₄ | 177.73 | 0.111 Li₃NbO₄ + 0.889 HF → 0.111 LiNbF₆ + | 8.01 | 0.50 | −0.265 | 1.17 | 1.67 | 9.41 | 322.3% |
| | | 0.444 H₂O + 0.222 LiF | | | | | | | |
| Li₄MoO₅ | 203.7 | 0.8 HF + 0.2 Li₄MoO₅ → 0.2 MoO₃ + 0.4 | 4.00 | 1.00 | −0.252 | 1.23 | 2.23 | 10.97 | 276.6% |
| | | H₂O + 0.8 LiF | | | | | | | |
| Li₂MoO₄ | 173.82 | 0.917 HF + 0.083 Li₂MoO₄ → 0.25 H₃OF + | 11.05 | 0.36 | −0.178 | 1.75 | 2.11 | 12.13 | 250.0% |
| | | 0.083 MoOF₄ + 0.167 LiHF₂ | | | | | | | |
| Li₂SnO₃ | 180.59 | 0.143 Li₂SnO₃ + 0.857 HF → 0.143 Li₂SnF₆ + | 5.99 | 0.67 | −0.284 | 1.10 | 1.76 | 9.76 | 310.9% |
| | | 0.429 H₂O | | | | | | | |
| Li₈SnO₆ | 270.23 | 0.111 Li8SnO₆ + 0.889 HF → 0.444 H₂O + | 8.01 | 0.50 | −0.422 | 0.74 | 1.24 | 4.58 | 663.1% |
| | | 0.889 LiF + 0.111 SnO₂ | | | | | | | |
| Li₅SbO₅ | 236.46 | 0.176 Li5SbO₅ + 0.824 HF → 0.059 LiSb₃O₈ + | 4.68 | 0.85 | −0.313 | 0.99 | 1.85 | 7.82 | 388.2% |
| | | 0.412 H₂O + 0.824 LiF | | | | | | | |

Chemical reactivity against LiF and LiOH. Electrolyte decomposition leads to the formation of solid electrolyte interface (SEI), which is mainly composed of LiF, Li₂O, Li₂CO₃ and other insoluble products. In Table 5, LiF reactivity was posited against a number of the Li-M-O identified above, with a positive result would be no reaction. It was determined that all Li-M-O compounds identified are expected to be stable toward LiF.

TABLE 5
LiF stability evaluations with Li—M—O coating candidates.

| Compounds | LiF |
|---|---|
| LiAlO₂ | Stable with LiF |
| Li₅AlO₄ | Stable with LiF |
| LiScO₂ | Stable with LiF |
| Li₄TiO₄ | Stable with LiF |
| Li₂TiO₃ | Stable with LiF |
| Li₂MnO₃ | Stable with LiF |
| LiFeO₂ | Stable with LiF |
| Li₂FeO₃ | Stable with LiF |
| Li₅FeO₄ | Stable with LiF |
| Li₂CoO₃ | Stable with LiF |
| LiNi₂O₄ | Stable with LiF |
| LiNiO₂ | Stable with LiF |
| Li₂NiO₃ | Stable with LiF |
| LiCuO₂ | Stable with LiF |
| Li₃CuO₃ | Stable with LiF |
| LiYO₂ | Stable with LiF |
| Li₂ZrO₃ | Stable with LiF |
| Li₆Zr₂O₇ | Stable with LiF |
| Li₈Nb₂O₉ | Stable with LiF |
| Li₃NbO₄ | Stable with LiF |
| Li₄MoO₅ | Stable with LiF |
| Li₂MoO₄ | Stable with LiF |
| Li₂SnO₃ | Stable with LiF |
| Li₈SnO₆ | Stable with LiF |
| Li₅SbO₅ | Stable with LiF |

LiOH is another chemical that are may be present at the surface of cathode materials, depending on the choice of Li salt precursors. For nickel-rich cathode materials, it may be preferable to use LiOH as a lithium precursor instead of other lithium precursors, for example lithium carbonate. LiOH generation at the surface of the cathode leads to formation of H₂O, which can subsequently form HF. Similar to the LiF reactions from Table 5, no predicted reaction with LiOH is desirable. Table 6 presents the data for the compounds.

TABLE 6
LiOH stability evaluations with Li—M—O coating candidates.

| | | Eᵣₓₙ |
|---|---|---|
| Compounds | LiOH Reactions | (eV/atom) |
| LiAlO₂ | Stable with LiOH | N/A |
| Li₅AlO₄ | Stable with LiOH | N/A |
| LiScO₂ | Stable with LiOH | N/A |
| Li₄TiO₄ | Stable with LiOH | N/A |
| Li₂TiO₃ | Stable with LiOH | N/A |
| Li₂MnO₃ | Stable with LiOH | N/A |
| LiFeO₂ | Stable with LiOH | N/A |
| Li₂FeO₃ | Stable with LiOH | N/A |
| Li₅FeO₄ | Stable with LiOH | N/A |
| Li₂CoO₃ | Stable with LiOH | N/A |
| LiNi₂O₄ | 0.667 LiOH + 0.333 LiNi₂O₄ → | −0.001 |
| | 0.333 LiNiO₂ + 0.333 Li₂NiO₃ + | |
| | 0.333 H₂O | |
| LiNiO₂ | Stable with LiOH | N/A |
| Li₂NiO₃ | Stable with LiOH | N/A |
| LiCuO₂ | Stable with LiOH | N/A |
| Li₃CuO₃ | Stable with LiOH | N/A |
| LiYO₂ | Stable with LiOH | N/A |
| Li₂ZrO₃ | Stable with LiOH | N/A |
| Li₆Zr₂O₇ | Stable with LiOH | N/A |
| Li₈Nb₂O₉ | Stable with LiOH | N/A |
| Li₃NbO₄ | Stable with LiOH | N/A |
| Li₄MoO₅ | Stable with LiOH | N/A |
| Li₂MoO₄ | Stable with LiOH | N/A |
| Li₂SnO₃ | Stable with LiOH | N/A |
| Li₈SnO₆ | Stable with LiOH | N/A |
| Li₅SbO₅ | Stable with LiOH | N/A |

Chemical reactivity against PF₅⁻ PF₅⁻ is a species that forms from LiPF₆ salt decomposition: LiPF₆↔LiF+PF₅⁻. Similar to HF, PF₅⁻ will decompose NMC811. Therefore, it is desirable that the Li-M-O materials react with and scavenge PF₅⁻.

TABLE 7
PF₅_{^{−}} reactions with NMC811 cathode materials.

| Molar | | Erxn |
|---|---|---|
| Fraction | PF₅_{^{−}} reactions | [eV/atom] |
| 0.048 | 0.952 Li₁Mn_{0.1}Co_{0.1}Ni_{0.8}O₂ + 0.048 PF₅ → 0.19 Li(NiO₂)₂ + 0.381 | −0.095 |
| | NiO + 0.048 Li₃PO₄ + 0.095 Li₂CoO₃ + 0.095 Li₂MnO₃ + 0.238 LiF | |
| 0.062 | 0.938 Li₁Mn_{0.1}Co_{0.1}Ni_{0.8}O₂ + 0.062 PF₅ → 0.213 Li(NiO₂)₂ + 0.325 | −0.123 |
| | NiO + 0.019 Li₄MnCo₅O₁₂ + 0.062 Li₃PO₄ + 0.075 Li₂MnO₃ + | |
| | 0.312 LiF | |
| 0.074 | 0.926 Li₁Mn_{0.1}Co_{0.1}Ni_{0.8}O₂ + 0.074 PF₅ → 0.21 Li(NiO₂)₂ + 0.025 | −0.143 |
| | Li₂Mn₃NiO₈ + 0.296 NiO + 0.019 Li₄MnCo₅O₁₂ + 0.074 Li₃PO₄ + | |
| | 0.37 LiF | |
| 0.093 | 0.907 Li₁Mn_{0.1}Co_{0.1}Ni_{0.8}O₂ + 0.093 PF₅ → 0.024 Li₂Mn₃NiO₈ + | −0.173 |
| | 0.041 LiO₈ + 0.701 NiO + 0.018 Li₄MnCo₅O₁₂ + 0.093 Li₃PO₄ + | |
| | 0.466 LiF | |
| 0.097 | 0.903 Li₁Mn_{0.1}Co_{0.1}Ni_{0.8}O₂ + 0.097 PF₅ → 0.024 Li₂Mn₃NiO₈ + | −0.178 |
| | 0.233 Ni₃O₄ + 0.01 LiO₈ + 0.018 Li₄MnCo₅O₁₂ + 0.097 Li₃PO₄ + | |
| | 0.483 LiF | |
| 0.100 | 0.9 Li₁Mn_{0.1}Co_{0.1}Ni_{0.8}O₂ + 0.1 PF₅ → 0.072 Mn(Ni₃O₄)₂ + 0.096 | −0.182 |
| | Ni₃O₄ + 0.028 LiO₈ + 0.018 Li₄MnCo₅O₁₂ + 0.1 Li₃PO₄ + 0.5 LiF | |
| 0.103 | 0.897 Li₁Mn_{0.1}Co_{0.1}Ni_{0.8}O₂ + 0.103 PF₅ → 0.072 Mn(Ni₃O₄)₂ + | −0.186 |
| | 0.096 Ni₃O₄ + 0.018 Li₄MnCo₅O₁₂ + 0.103 Li₃PO₄ + 0.516 LiF + | |
| | 0.105 O₂ | |
| 0.106 | 0.894 Li₁Mn_{0.1}Co_{0.1}Ni_{0.8}O₂ + 0.106 PF₅ → 0.089 Mn(Ni₃O₄)₂ + 0.06 | −0.189 |
| | Ni₃O₄ + 0.045 Li(CoO₂)₂ + 0.106 Li₃PO₄ + 0.531 LiF + 0.115 O₂ | |
| 0.137 | 0.863 Li₁Mn_{0.1}Co_{0.1}Ni_{0.8}O₂ + 0.137 PF₅ → 0.086 Mn(Ni₃O₄)₂ + | −0.216 |
| | 0.012 Ni₃O₄ + 0.043 Li(CoO₂)₂ + 0.137 LiNiPO₄ + 0.683 LiF + | |
| | 0.134 O₂ | |
| 0.144 | 0.856 Li₁Mn_{0.1}Co_{0.1}Ni_{0.8}O₂ + 0.144 PF₅ → 0.086 Mn(Ni₃O₄)₂ + | −0.221 |
| | 0.043 Li(CoO₂)₂ + 0.144 LiNiPO₄ + 0.027 Li₂NiF₄ + 0.615 LiF + | |
| | 0.139 O₂ | |
| 0.213 | 0.787 Li₁Mn_{0.1}Co_{0.1}Ni_{0.8}O₂ + 0.213 PF₅ → 0.014 Mn(Ni₃O₄)₂ + | −0.268 |
| | 0.065 MnNiO₃ + 0.039 Li(CoO₂)₂ + 0.213 LiNiPO₄ + 0.267 Li₂NiF₄ + | |
| | 0.128 O₂ | |
| 0.227 | 0.773 Li₁Mn_{0.1}Co_{0.1}Ni_{0.8}O₂ + 0.227 PF₅ → 0.077 MnNiO₃ + 0.039 | −0.276 |
| | Li(CoO₂)₂ + 0.167 LiNiPO₄ + 0.03 Ni₃(PO₄)₂ + 0.284 Li₂NiF₄ + | |
| | 0.126 O₂ | |
| 0.231 | 0.769 Li₁Mn_{0.1}Co_{0.1}Ni_{0.8}O₂ + 0.231 PF₅ → 0.051 MnNiO₃ + 0.141 | −0.278 |
| | LiNiPO₄ + 0.026 Li₂MnCo₃O₈ + 0.045 Ni₃(PO₄)₂ + 0.288 Li₂NiF₄ + | |
| | 0.128 O₂ | |
| 0.234 | 0.766 Li₁Mn_{0.1}Co_{0.1}Ni_{0.8}O₂ + 0.234 PF₅ → 0.017 Li₂Mn₃NiO₈ + | −0.280 |
| | 0.096 LiNiPO₄ + 0.026 Li₂MnCo₃O₈ + 0.069 Ni₃(PO₄)₂ + 0.293 | |
| | Li₂NiF₄ + 0.128 O₂ | |
| 0.241 | 0.759 Li₁Mn_{0.1}Co_{0.1}Ni_{0.8}O₂ + 0.241 PF₅ → 0.108 LiNiPO₄ + 0.025 | −0.282 |
| | Li₂MnCo₃O₈ + 0.066 Ni₃(PO₄)₂ + 0.051 MnO₂ + 0.301 Li₂NiF₄ + | |
| | 0.127 O₂ | |
| 0.245 | 0.755 Li₁Mn_{0.1}Co_{0.1}Ni_{0.8}O₂ + 0.245 PF₅ → 0.142 LiNiPO₄ + 0.052 | −0.284 |
| | Ni₃(PO₄)₂ + 0.075 CoO₂ + 0.075 MnO₂ + 0.307 Li₂NiF₄ + 0.113 O₂ | |
| 0.261 | 0.739 Li₁Mn_{0.1}Co_{0.1}Ni_{0.8}O₂ + 0.261 PF₅ → 0.043 Li₂Ni₃(P₂O₇)₂ + | −0.286 |
| | 0.045 Ni₃(PO₄)₂ + 0.074 CoO₂ + 0.074 MnO₂ + 0.327 Li₂NiF₄ + | |
| | 0.111 O₂ | |
| 0.274 | 0.726 Li₁Mn_{0.1}Co_{0.1}Ni_{0.8}O₂ + 0.274 PF₅ → 0.021 Li₂Ni₃(P₂O₇)₂ + | −0.287 |
| | 0.059 Ni₃(PO₄)₂ + 0.073 MnO₂ + 0.342 Li₂NiF₄ + 0.073 CoPO₄ + | |
| | 0.127 O₂ | |
| 0.286 | 0.714 Li₁Mn_{0.1}Co_{0.1}Ni_{0.8}O₂ + 0.286 PF₅ → 0.054 Li₂Ni₃(P₂O₇)₂ + | −0.287 |
| | 0.071 MnO₂ + 0.304 Li₂NiF₄ + 0.071 CoPO₄ + 0.107 NiF₂ + 0.125 | |
| | O₂ | |
| 0.300 | 0.7 Li₁Mn_{0.1}Co_{0.1}Ni_{0.8}O₂ + 0.3 PF₅ → 0.04 Li₂Ni₃(P₂O₇)₂ + 0.07 | −0.286 |
| | LiMnPO₄F + 0.275 Li₂NiF₄ + 0.07 CoPO₄ + 0.165 NiF₂ + 0.14 O₂ | |
| 0.306 | 0.694 Li₁Mn_{0.1}Co_{0.1}Ni_{0.8}O₂ + 0.306 PF₅ → 0.056 LiNi₂P₃O₁₀ + | −0.286 |
| | 0.069 LiMnPO₄F + 0.285 Li₂NiF₄ + 0.069 CoPO₄ + 0.16 NiF₂ + | |
| | 0.139 O₂ | |
| 0.324 | 0.676 Li₁Mn_{0.1}Co_{0.1}Ni_{0.8}O₂ + 0.324 PF₅ → 0.068 Li₃MnO₂(O₃F₂)₂ + | −0.284 |
| | 0.041 LiNi₂P₃O₁₀ + 0.216 Li₂NiF₄ + 0.068 CoPO₄ + 0.243 NiF₂ + | |
| | 0.135 O₂ | |
| 0.333 | 0.667 Li₁Mn_{0.1}Co_{0.1}Ni_{0.8}O₂ + 0.333 PF₅ → 0.067 Li₃MnO₂(O₃F₂)₂ + | −0.283 |
| | 0.067 Ni(PO₃)₂ + 0.233 Li₂NiF₄ + 0.067 CoPO₄ + 0.233 NiF₂ + | |
| | 0.133 O₂ | |
| 0.545 | 0.455 Li₁Mn_{0.1}Co_{0.1}Ni_{0.8}O₂ + 0.545 PF₅ → 0.045 Li₃MnO₂(O₃F₂)₂ + | −0.204 |
| | 0.045 Ni(PO₃)₂ + 0.045 CoPO₄ + 0.318 LiOF₆ + 0.318 NiF₂ + 0.091 | |
| | O₂ | |
| 0.568 | 0.432 Li₁Mn_{0.1}Co_{0.1}Ni_{0.8}O₂ + 0.568 PF₅ → 0.09 Ni(PO₃)₂ + 0.043 | −0.196 |
| | CoPO₄ + 0.345 LiPF₆ + 0.043 Li₂MnF₆ + 0.255 NiF₂ + 0.076 O₂ | |
| 0.583 | 0.417 Li₁Mn_{0.1}Co_{0.1}Ni_{0.8}O₂ + 0.583 PF₅ → 0.042 LiMnF₄ + 0.083 | −0.191 |
| | Ni(PO₃)₂ + 0.042 CoPO₄ + 0.375 LiPF₆ + 0.25 NiF₂ + 0.083 O₂ | |
| 0.597 | 0.403 Li₁Mn_{0.1}Co_{0.1}Ni_{0.8}O₂ + 0.597 PF₅ → 0.04 MnP₂O₇ + 0.037 | −0.186 |
| | Ni(PO₃)₂ + 0.04 CoPO₄ + 0.403 LiPF₆ + 0.285 NiF₂ + 0.07 O₂ | |
| 0.600 | 0.4 Li₁Mn_{0.1}Co_{0.1}Ni_{0.8}O₂ + 0.6 PF₅ → 0.04 MnP₂O₇ + 0.06 Ni(PO₃)₂ + | −0.184 |
| | 0.4 LiPF₆ + 0.26 NiF₂ + 0.04 CoF₂ + 0.08 O₂ | |
| 1.000 | PF₅ → PF₅ | 0.000 |

Table 8 shows PF₅⁻ reactions for Li-M-O compounds. Similar to HF, the Li-M-O compounds should scavenge PF₅⁻.

TABLE 8
PF₅⁻ reactions with Li-M-O coating candidates.

| | | | vs. | Eᵣₓₙ | vs. | | Per | PF₅⁻ |
|---|---|---|---|---|---|---|---|---|
| Compounds | PF₅⁻ reactions | Ratio | AlPO₄ | (eV/atom) | AlPO₄ | Sum | weight | Score |
| LiAlO₂ | 0.333 PF₅ + 0.667 LiAlO₂ → | 0.50 | 1.00 | −0.351 | 1.00 | 2.00 | 30.34 | 100.00% |
| | 0.222 Li₃AlF₆ + 0.111 AlF₃ + | | | | | | | |
| | 0.333 AlPO₄ | | | | | | | |
| Li₅AlO₄ | 0.5 PF₅ + 0.5 Li₅AlO₄ → | 1.00 | 0.50 | −0.487 | 0.72 | 1.22 | 9.71 | 312.55% |
| | 0.417 Li3AlF₆ + 0.417 Li3PO4 + | | | | | | | |
| | 0.083 AlPO4 | | | | | | | |
| LiScO₂ | 0.364 PF₅ + 0.636 LiScO₂ → | 0.57 | 0.87 | −0.064 | 5.48 | 6.36 | 75.77 | 40.04% |
| | 0.182 LiScP₂O₇ + 0.152 | | | | | | | |
| | Li3ScF₆ + 0.303 ScF₃ | | | | | | | |
| Li₄TiO₄ | 0.5 Li₄TiO₄ + 0.5 PF₅ → 0.167 | 1.00 | 0.50 | −0.387 | 0.91 | 1.41 | 10.07 | 301.26% |
| | LiTi₂(PO₄)₃ + 0.167 Li₂TiF₆ + | | | | | | | |
| | 1.5 LiF | | | | | | | |
| Li₂TiO₃ | 0.571 Li₂TiO₃ + 0.429 PF₅ → | 0.75 | 0.66 | −0.122 | 2.88 | 3.54 | 32.27 | 94.02% |
| | 0.143 LiTi₂(PO₄)₃ + 0.286 | | | | | | | |
| | Li₂TiF₆ + 0.429 LiF | | | | | | | |
| Li₂MnO₃ | 0.448 PF₅ + 0.552 Li₂MnO₃ → | 0.81 | 0.62 | −0.063 | 5.57 | 6.19 | 52.96 | 57.29% |
| | 0.149 Li₃MnP₂(O₃F₂)₂ + 0.328 | | | | | | | |
| | Li₂MnF₅ + 0.075 MnP₂O₇ + | | | | | | | |
| | 0.119 O₂ | | | | | | | |
| LiFeO₂ | 0.667 LiFeO₂ + 0.333 PF₅ → | 0.50 | 1.00 | −0.088 | 3.99 | 4.99 | 52.63 | 57.64% |
| | 0.111 FeF₃ + 0.222 Li3FeF₆ + | | | | | | | |
| | 0.333 FePO₄ | | | | | | | |
| Li₂FeO₃ | 0.6 Li₂FeO₃ + 0.4 PF₅ → 0.2 | 0.67 | 0.75 | −0.340 | 1.03 | 1.78 | 15.13 | 200.53% |
| | LiFePO₄F + 0.1 LiFeP₂O₇ + | | | | | | | |
| | 0.3 Li3FeF₆ + 0.15 O₂ | | | | | | | |
| Li₅FeO₄ | 0.5 Li₅FeO₄ + 0.5 PF₅ → 0.5 | 1.00 | 0.50 | −0.473 | 0.74 | 1.24 | 8.03 | 377.74% |
| | LiFePO₄F + 2 LiF | | | | | | | |
| Li₂CoO₃ | 0.286 PF₅ + 0.714 Li₂CoO₃ → | 0.40 | 1.25 | −0.006 | 58.50 | 59.75 | 494.55 | 6.13% |
| | 0.429 CoO₂ + 0.286 CoPO₄ + | | | | | | | |
| | 1.429 LiF + 0.071 O₂ | | | | | | | |
| LiNi₂O₄ | 0.417 PF₅ + 0.583 Li(NiO₂)₂ → | 0.72 | 0.70 | −0.029 | 12.10 | 12.80 | 67.97 | 44.63% |
| | 0.188 Li₂NiF₄ + 0.104 | | | | | | | |
| | Li₂Ni₃(P₂O₇)₂ + 0.667 NiF₂ + | | | | | | | |
| | 0.438 O₂ | | | | | | | |
| LiNiO₂ | 0.3 PF₅ + 0.7 LiNiO₂ → 0.275 | 0.43 | 1.16 | −0.205 | 1.71 | 2.88 | 29.47 | 102.95% |
| | Li₂NiF₄ + 0.075 Li₂Ni₃(P₂O₇)2 + | | | | | | | |
| | 0.2 NiF₂ + 0.175 O₂ | | | | | | | |
| Li₂NiO₃ | 0.364 PF₅ + 0.636 Li₂NiO₃ → | 0.57 | 0.87 | −0.065 | 5.40 | 6.27 | 52.02 | 58.32% |
| | 0.364 Li₂NiF₄ + 0.091 | | | | | | | |
| | Li₂Ni₃(P₂O₇)₂ + 0.364 LiF + | | | | | | | |
| | 0.318 O2 | | | | | | | |
| LiCuO₂ | 0.167 PF₅ + 0.833 LiCuO₂ → | 0.20 | 2.49 | −0.065 | 5.40 | 7.89 | 76.99 | 39.41% |
| | 0.167 Cu₂PO₅ + 0.25 Cu₂O₃ + | | | | | | | |
| | 0.833 LiF + 0.042 O₂ | | | | | | | |
| Li₃CuO₃ | 0.333 PF₅ + 0.667 Li₃CuO₃ → | 0.50 | 1.00 | −0.351 | 1.00 | 2.00 | 15.11 | 200.80% |
| | 0.25 Cu₂O₃ + 0.167 Li₂CuP₂O₇ + | | | | | | | |
| | 1.667 LiF + 0.042 O₂ | | | | | | | |
| LiYO₂ | 0.333 PF₅ + 0.667 LiYO₂ → | 0.50 | 1.00 | −0.564 | 0.62 | 1.62 | 12.69 | 239.10% |
| | 0.25 YPO₄ + 0.417 LiYF₄ + | | | | | | | |
| | 0.083 Li₃PO₄ | | | | | | | |
| Li₂ZrO₃ | 0.429 PF₅ + 0.571 Li₂ZrO₃ → | 0.75 | 0.66 | −0.070 | 5.01 | 5.68 | 37.09 | 81.80% |
| | 0.214 Li₄ZrF₈ + 0.143 | | | | | | | |
| | LiZr₂(PO₄)₃ + 0.071 Li₂ZrF₆ | | | | | | | |
| Li₆Zr₂O₇ | 0.636 PF₅ + 0.364 Li₆Zr₂O₇ → | 1.75 | 0.29 | −0.060 | 5.85 | 6.14 | 18.26 | 166.19% |
| | 0.303 Li₄ZrF₈ + 0.212 | | | | | | | |
| | LiZr₂(PO₄)₃ + 0.758 LIF | | | | | | | |
| Li₈Nb₂O₉ | 0.357 Li₈Nb₂O₉ + 0.643 PF₅ → | 1.80 | 0.28 | −0.060 | 5.85 | 6.13 | 15.90 | 190.81% |
| | 0.643 NbPO₅ + 0.071 LiNbF₆ + | | | | | | | |
| | 2.786 LiF | | | | | | | |
| Li₃NbO₄ | 0.556 Li₃NbO₄ + 0.444 PF₅ → | 0.80 | 0.63 | −0.297 | 1.18 | 1.81 | 10.17 | 298.41% |
| | 0.444 NbPO₅ + 0.111 LiNbF₆ + | | | | | | | |
| | 1.556 LiF | | | | | | | |
| Li₄MoO₅ | 0.444 PF₅ + 0.556 Li₄MoO₅ → | 0.80 | 0.63 | −0.257 | 1.37 | 1.99 | 9.77 | 310.42% |
| | 0.222 Mo₂P₂O₁₁ + 0.111 MoO₃ + | | | | | | | |
| | 2.222 LiF | | | | | | | |
| Li₂MoO₄ | 0.4 PF₅ + 0.6 Li₂MoO₄ → 0.2 | 0.67 | 0.75 | −0.120 | 2.93 | 3.67 | 21.14 | 143.55% |
| | Mo₂P₂O₁₁ + 0.2 MoOF₄ + 1.2 | | | | | | | |
| | LiF | | | | | | | |
| Li₂SnO₃ | 0.571 Li₂SnO₃ + 0.429 PF₅ → | 0.75 | 0.66 | −0.311 | 1.13 | 1.79 | 9.93 | 305.56% |
| | 0.143 LiSn₆2(PO4)₃ + 0.286 | | | | | | | |
| | Li₂SnF₆ + 0.429 LiF | | | | | | | |
| Li₈SnO₆ | 0.5 Li₈SnO₆ + 0.5 PF₅ → 0.5 | 1.00 | 0.50 | −0.492 | 0.71 | 1.21 | 4.49 | 676.09% |
| | Li3PO4 + 2.5 LiF + 0.5 SnO2 | | | | | | | |
| Li₅SbO₅ | 0.5 Li₅SbO₅ + 0.5 PF₅ → 0.5 | 1.00 | 0.50 | −0.338 | 1.04 | 1.54 | 6.50 | 466.55% |
| | SbPO₅ + 2.5 LiF | | | | | | | |

Li-M-O candidate evaluation. After testing chemical reactivity against HF, LiF, PF₅, and LiOH, we identified the following Li-M-O candidates that are expected to be superior to LiAlO₂ in one or more of the testing conditions and that will form a stable interface when in contact with NMC811 cathode materials. The Li-M-O candidates may include, but are not limited to, Li₅AlO₄, Li₄TiO₄, Li₅FeO₄, LiNiO₂, Li₃CuO₃, Li₆Zr₂O₇, Li₈Nb₂O₉, Li₃NbO₄, Li₄MoO₅, Li₂MoO₄, Li₂SnO₃, Li₈SnO₆, Li₂FeO₃, LiYO₂, Li₅SbO₅, LiScO₂, Li₂TiO₃, Li₂MnO₃, LiFeO₂, Li₂CoO₃, LiNi₂O₄, Li₂NiO₃, Li₂ZrO₃, and combinations of any two or more thereof.

Experimental procedure (prophetic). A metal-containing precursor chemical including but not limited to metal nitrates, chloride, sulfate, etc. is dissolved in water or an organic solvent. This method may include but not limited to co-precipitation method in a continuously stirred tank reactor (CSTR). The solution will be mixed with NMC811 precursors or as-synthesized NMC811 materials at room temperature or elevated temperature with an aging time varying from 5 min to 24 hours. The pH of the solution may be controlled by the presence of acid or base in order to precipitate well-mixed precursor compounds. Then, the mixture will be annealed at elevated temperature may be any of the following values or in a range of any two of the following values: 200, 400, 600, 800, and 1,000° C. The aging time may be any of the following values or in a range of any two of the following values: 1, 2, 3, 4, 8, 12, 16, 24, 36, 48, 60, and 72 hours. Depending on the choice of coatings, reducing/oxidizing conditions may vary by presence of different gas agents including but not limited to N₂, O₂, Air, Ar, H₂, CO, CO₂, mixture thereof, etc. The materials may include a thin coating layer at the outer surface in a form of island or conformal coatings.

Variously sized Li-M-O coated cathode materials can be also synthesized via a solid-state method. The primary particle size range may any of the following values or in a range of any two of the following values: 50, 60, 70, 80, 90, 100, 110, 120, 130, 140, 150, 160, 170, 180, 190, 200, 300, 400, 500, 600, 700, 800, or 900 nm. In another embodiment, the secondary size range may any of the following values or in a range of any two of the following values: 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, and 20 μm. One method of performing solid-state synthesis is a ball-milling process. The solid-state method may be followed by an optional spray dryer processing step to facilitate the drying and secondary particle formation. The optimal amount of metal phosphate and its chemical composition at the electrode material surface may be tuned by the secondary heat-treatment conditions may be any of the following values or in a range of any two of the following values: 200, 400, 600, 800, and 1,000° C. in the presence of reducing gas agents such as N₂, Ar, H₂, or gas mixture thereof.

In another embodiment, Li-M-O coating materials may be deposited on the synthesized electrode active materials, as a post-treatment step. Non-limiting examples of deposition techniques include chemical vapor deposition, physical vapor deposition, pulsed laser deposition, emulsion, sol-gel, atomic layer deposition, and/or other deposition techniques.

The Li-M-O coating materials will be mixed with carbon and binder materials in N-methylpyrrolidone (NMP) solution to form a slurry. The slurry will be coated onto an Al foil, and dried in the oven to remove the NMP. The loading level of cathode materials be from about 5 to 50 mg/cm2, and the packing density may vary from 1.0 to 5.0 g/cc. The electrode is to be assembled as the cathode in Li-ion batteries, where the anode materials can be Li metal, graphite, Si, SiOₓ, Si nanowire, lithiated Si, or mixture thereof. A traditional liquid electrolyte with LiPF₆ salt, dissolved in carbonate solutions may be used. In other embodiments, a solid-state electrolyte including but not limited to oxide, sulfide, or phosphates-based crystalline structure may replace the liquid electrolyte. The cell configuration may be prismatic, cylindrical, or pouch type. Each cell can further configured together to design pack, module, or stack with desired power output.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or devices, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A cathode active material comprising a bulk nickel-rich cathode active material having a ternary lithium metal oxide coating on a surface of the bulk nickel-rich cathode active material, wherein the ternary lithium metal oxide is other than LiAlO₂.

2. The cathode active material of claim 1, wherein the ternary lithium metal oxide coating comprises:
a greater PF₅⁻ score when normalized to that of LiAlO₂ at 100%;
a greater HF score when normalized to that of LiAlO₂ at 100%; or
in absolute terms, an enthalpy of reaction value that is less than −0.351 eV/atom; or
a combination thereof.

3. The cathode active material of claim 1, wherein the ternary lithium metal oxide is Li₅AlO₄, Li₄TiO₄, Li₅FeO₄, LiNiO₂, Li₃CuO₃, Li₆Zr₂O₇, Li₈Nb₂O₉, Li₃NbO₄, Li₄MoO₅, Li₂MoO₄, Li₂SnO₃, Li₈SnO₆, Li₂FeO₃, LiYO₂, Li₅SbO₅, LiScO₂, Li₂TiO₃, Li₂MnO₃, LiFeO₂, Li₂CoO₃, LiNi₂O₄, Li₂NiO₃, Li₂ZrO₃, or a mixture of any two or more thereof.

4. The cathode active material of claim 1, wherein the ternary lithium metal oxide is Li₅AlO₄, Li₄TiO₄, Li₅FeO₄, LiNiO₂, Li₃CuO₃, Li₆Zr₂O₇, Li₈Nb₂O₉, Li₃NbO₄, Li₄MoO₅, Li₂MoO₄, Li₂SnO₃, Li₈SnO₆, Li₂FeO₃, LiYO₂, Li₅SbO₅, or a mixture of any two or more thereof.

5. The cathode active material of claim 1, wherein the ternary lithium metal oxide is Li₅AlO₄, Li₄TiO₄, Li₅FeO₄, LiNiO₂, Li₃CuO₃, Li₆Zr₂O₇, Li₈Nb₂O₉, Li₃NbO₄, Li₄MoO₅, Li₂MoO₄, Li₂SnO₃, Li₈SnO₆, or a mixture of any two or more thereof.

6. The cathode active material of claim 1, wherein the bulk nickel-rich cathode active material comprises at least greater than 70 wt % Ni.

7. The cathode active material of claim 1, wherein the bulk nickel-rich cathode active material is at least greater than 80 wt % Ni.

8. The cathode active material of claim 1, wherein the bulk nickel-rich cathode active material is Li(NiₐMn_{b}Co_{c})O₂, wherein 0≤a≤1, 0≤b≤1, 0≤c≤1, and a+b+c=1.

9. The cathode active material of claim 1, wherein the ternary lithium metal oxide coating has a greater phase stability in the presence the nickel-rich cathode active material.

10. The cathode active material of claim 1, wherein the ternary lithium metal oxide coating exhibits a greater phase stability than LiAlO₂ in the presence of the nickel-rich cathode active material.

11. The cathode active material of claim 1, wherein the bulk nickel-rich cathode active material is LiCoO₂, Li(NiₐMn_{b}Co_{c})O₂, or Li(Mn_{α}Ni_{β})₂O₄, wherein a+b+c=1, and α+β=1.

12. A current collector comprising a metal coated with a cathode active material comprising a bulk nickel-rich cathode active material having a ternary lithium metal oxide coating on a surface of the bulk cathode active material, wherein the ternary lithium metal oxide is other than LiAlO₂.

13. The current collector claim 12, wherein the ternary lithium metal oxide is Li₅AlO₄, Li₄TiO₄, Li₅FeO₄, LiNiO₂, Li₃CuO₃, Li₆Zr₂O₇, Li₈Nb₂O₉, Li₃NbO₄, Li₄MoO₅, Li₂MoO₄, Li₂SnO₃, Li₈SnO₆, Li₂FeO₃, LiYO₂, Li₅SbO₅, LiScO₂, Li₂TiO₃, Li₂MnO₃, LiFeO₂, Li₂CoO₃, LiNi₂O₄, Li₂NiO₃, Li₂ZrO₃, or a mixture of any two or more thereof.

14. The current collector claim 12, wherein the ternary lithium metal oxide is Li₅AlO₄, Li₄TiO₄, Li₅FeO₄, LiNiO₂, Li₃CuO₃, Li₆Zr₂O₇, Li₈Nb₂O₉, Li₃NbO₄, Li₄MoO₅, Li₂MoO₄, Li₂SnO₃, Li₈SnO₆, Li₂FeO₃, LiYO₂, Li₅SbO₅, or a mixture of any two or more thereof.

15. The current collector claim 12, wherein the ternary lithium metal oxide is Li₅AlO₄, Li₄TiO₄, Li₅FeO₄, LiNiO₂, Li₃CuO₃, Li₆Zr₂O₇, Li₈Nb₂O₉, Li₃NbO₄, Li₄MoO₅, Li₂MoO₄, Li₂SnO₃, Li₈SnO₆, or a mixture of any two or more thereof.

16. The current collector claim 12, wherein the metal is Al, Cu, Ni, Fe, Ti, or combination thereof.

17. A lithium ion battery comprising:
a cathode comprising a bulk nickel-rich cathode active material and a current collector;
an anode;
a separator;
an electrolyte; and
a housing;
wherein:
the bulk nickel-rich cathode active material is a nickel-rich cathode active material having a ternary lithium metal oxide coating on a surface of the particulate bulk nickel-rich cathode active material, wherein the ternary lithium metal oxide is other than LiAlO₂.

18. The lithium ion battery of claim 17, wherein the ternary lithium metal oxide exhibits:
a greater PF₅⁻ score when normalized to that of LiAlO₂ at 100%;
a greater HF score when normalized to that of LiAlO₂ at 100%;
in absolute terms, an enthalpy of reaction value that is less than −0.351 eV/atom; or
a combination thereof.

19. The lithium ion battery of claim 17, wherein the ternary lithium metal oxide is Li₅AlO₄, Li₄TiO₄, Li₅FeO₄, LiNiO₂, Li₃CuO₃, Li₆Zr₂O₇, Li₈Nb₂O₉, Li₃NbO₄, Li₄MoO₅, Li₂MoO₄, Li₂SnO₃, Li₈SnO₆, Li₂FeO₃, LiYO₂, Li₅SbO₅, LiScO₂, Li₂TiO₃, Li₂MnO₃, LiFeO₂, Li₂CoO₃, LiNi₂O₄, Li₂NiO₃, Li₂ZrO₃, or a mixture of any two or more thereof.

20. The lithium ion battery of claim 17, wherein the ternary lithium metal oxide is Li₅AlO₄, Li₄TiO₄, Li₅FeO₄, LiNiO₂, Li₃CuO₃, Li₆Zr₂O₇, Li₈Nb₂O₉, Li₃NbO₄, Li₄MoO₅, Li₂MoO₄, Li₂SnO₃, Li₈SnO₆, Li₂FeO₃, LiYO₂, Li₅SbO₅, or a mixture of any two or more thereof.
